(19) United States
(12) Patent Application Publication
(10) Pub. No.: US 2019/0303181 A1
(43) Pub. Date: Oct. 3, 2019

(54) SYSTEM FOR PROVIDING HELP INFORMATION, METHOD FOR CONTROLLING DISPLAY OF HELP INFORMATION, AND NON-TRANSITORY RECORDING MEDIUM

(71) Applicants: Takuya MORI, Tokyo (JP); Koichiro MAEMURA, Kanagawa (JP)

(72) Inventors: Takuya MORI, Tokyo (JP); Koichiro MAEMURA, Kanagawa (JP)

(21) Appl. No.: 16/274,298

(22) Filed: Feb. 13, 2019

(30) Foreign Application Priority Data
Mar. 29, 2018 (JP) 2018-063587

(51) Int. Cl. G06F 9/451; H04N 1/00

(52) U.S. Cl. CPC G06F 9/453; H04N 1/0048; H04N 1/00506; H04N 1/00503

(57) ABSTRACT

A system for providing help information, including processing circuitry to: acquire, from an information processing apparatus, help request information indicating a request for help information relating to an operation of the information processing apparatus, the help request information including device information of the information processing apparatus and display screen information indicating a display screen displayed on the information processing apparatus; generate help screen information in accordance with the acquired help request information, the help screen information including instruction information for changing a status of the information processing apparatus; and transmit the generated help screen information to the information processing apparatus via a network.

### CROSS-REFERENCE TO RELATED APPLICATIONS

This patent application is based on and claims priority pursuant to 35 U.S.C. § 119(a) to Japanese Patent Application No. 2018-063587, filed on Mar. 29, 2018, in the Japan Patent Office, the entire disclosure of which is hereby incorporated by reference herein.

### BACKGROUND

### Technical Field

The present invention relates to a system for providing help information, a method for controlling display of help information, and a recording medium.

### Description of the Related Art

There are systems having a help function to allow a user to solve alone a problem that the user encounters when operating an information processing apparatus including various applications or a problem related to an error that occurs in the information processing apparatus during operation.

Such a system provides a help function by using an external server connected to the information processing apparatus via a network. The external server, which provides the help function, dynamically generates appropriate help information in accordance with a user who has requested the help function or in accordance with device information of the information processing apparatus, and provides the generated help information to the information processing apparatus which the user is using.

### SUMMARY

Example embodiments include a system for providing help information, including processing circuitry to: acquire, from an information processing apparatus, help request information indicating a request for help information relating to an operation of the information processing apparatus, the help request information including device information of the information processing apparatus and display screen information indicating a display screen displayed on the information processing apparatus; generate help screen information in accordance with the acquired help request information, the help screen information including instruction information for changing a status of the information processing apparatus; and transmit the generated help screen information to the information processing apparatus via a network.

The system include a server apparatus, and may further include an information processing apparatus.

Example embodiments of the present invention include a method performed by the above-described system, and a control program for causing the system to perform such method.

Example embodiments include an information processing apparatus, a method performed by the information processing apparatus, and a control program, which controls display of help information. The information processing apparatus performs: transmitting, to a server apparatus, help request information indicating a request for help information relating to an operation of the information processing apparatus, the help request information including device information of the information processing apparatus and display screen information indicating a display screen displayed on the information processing apparatus; receiving help screen information generated in accordance with the transmitted help request information via a network, the help screen information including instruction information for changing a status of the information processing apparatus; and displaying on a display a help screen based on the received help screen information.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 illustrates an example system configuration of a help information providing system according to an embodiment;

FIG. 2 illustrates an example hardware configuration of an information processing apparatus according to the embodiment;

FIG. 3 illustrates an example hardware configuration of a help server according to the embodiment;

FIG. 4 illustrates an example software configuration of the information processing apparatus according to the embodiment;

FIG. 5 illustrates an example functional configuration of the help information providing system according to the embodiment;

FIG. 6 illustrates an example of a help data table according to the embodiment;

FIG. 7 is a sequence diagram illustrating an exemplary process performed in the help information providing system according to the embodiment up to the display of a help screen on the information processing apparatus;

FIG. 8 illustrates an example display screen displayed on the information processing apparatus according to the embodiment before a help request is made;

FIG. 9 illustrates an example of a help screen displayed on the information processing apparatus according to the embodiment;

FIG. 10 is a flowchart illustrating an exemplary process performed by the help server according to the embodiment;

FIG. 11 illustrates an example display screen displayed on the information processing apparatus according to the embodiment before a help request is made;

FIG. 12 illustrates an example of a help screen initially displayed on the information processing apparatus according to the embodiment;

FIG. 13 illustrates an example of a help screen on the information processing apparatus according to the embodiment after a help item is selected;

FIG. 14 illustrates an example display screen immediately after the help screen is closed after the settings of the information processing apparatus according to the embodiment are changed;

FIG. 15 is a flowchart illustrating an exemplary process for a help application in the information processing apparatus according to the embodiment;

FIG. 16 is a sequence diagram illustrating an exemplary process performed in the help information providing system according to the embodiment when help information is used;

FIG. 17 is a sequence diagram illustrating an exemplary process performed in the help information providing system according to the embodiment when help information is not used;

FIG. 18 is a flowchart illustrating an exemplary process performed by the information processing apparatus according to the embodiment after the display of a help screen;

FIG. 19 illustrates an example of a help use state reference screen according to the embodiment;

FIG. 20 illustrates an example of a help use state reference screen according to the embodiment;

FIG. 21 is a sequence diagram illustrating an exemplary process performed in the help information providing system according to the embodiment for updating help data by referring to the use state of the help screen;

FIG. 22 illustrates an example display screen presented on an information processing apparatus according to a first modification of the embodiment before a help request is made;

FIG. 23 illustrates an example of a help screen initially displayed on the information processing apparatus according to the first modification of the embodiment;

FIG. 24 illustrates an example of a help screen on the information processing apparatus according to the first modification of the embodiment after a help item is selected; and

FIG. 25 illustrates an example of a help data table according to a second modification of the embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The following describes an embodiment of the present invention with reference to the drawings. In the description of the drawings, the same numerals represent the same or substantially the same components and no redundant description is provided.

Examples of a system having a help function include an image forming apparatus that stores, as video data, communications with a support terminal of a support person who supports a user in the operation of the image forming apparatus. The image forming apparatus further stores conversations between the support person and the operating user as audio data in association with the video data. The image forming apparatus reproduces the stored video data and audio data in accordance with a request from the operating user or any other user.

In the method described above, the image forming apparatus (e.g., an information processing apparatus) reproduces (or displays) the video data and the audio data, which is help information, and the user refers to the displayed help information and searches by themselves for a desired setting screen from multiple menu options within the information processing apparatus. Accordingly, to solve a problem, the user is required to understand the help information and then change the settings of the information processing apparatus. Thus, the problem is difficult to solve easily.

### System Configuration

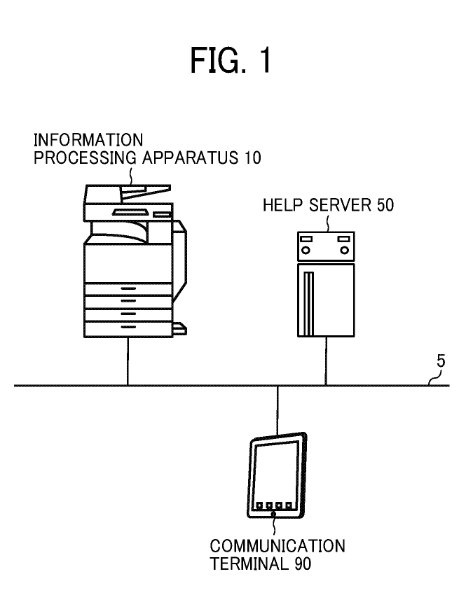

FIG. 1 illustrates an example system configuration of a help information providing system according to an embodiment. The help information providing system illustrated in FIG. 1 is a user support system for providing help information to a user to solve alone a problem that the user encounters with an information processing apparatus 10 during operation such as operating or setting a screen. The help information providing system is capable of providing help information so that the user may be more likely to solve alone a problem that the user encounters with the information processing apparatus 10 during operation.

The help information providing system is constituted by the information processing apparatus 10, a help server 50, and a communication terminal 90. The information processing apparatus 10, the help server 50, and the communication terminal 90 are connected to each other via a network 5. The network 5 is a communication network based on the Internet or a local area network (LAN). The network 5 may be a communication network to which the Internet and an intranet are connected via firewalls.

The information processing apparatus 10 has a browser function and performs processing, such as image processing, changing the settings, or checking setting conditions, in response to user input on an operation screen displayed on a browser. For example, when the user experiences a problem with the information processing apparatus 10 during operation, the information processing apparatus 10 transmits help request information 30 (described below) indicating a help request to the help server 50 in accordance with a user operation. The help request information 30 includes device information 31 (described below) for identifying the information processing apparatus 10. The help request information 30 further includes display screen information 32 (described below), which is information on the operation screen displayed on the information processing apparatus 10 when a help request is made through the user operation.

Further, the information processing apparatus 10 displays a help screen on the browser. The help screen is provided from the help server 50. Then, the information processing apparatus 10 performs a process of changing the status of the information processing apparatus 10 in accordance with a user input operation for instruction information included in the help screen (e.g., in accordance with the selection of instruction information for changing the settings). The status of the information processing apparatus 10 may indicate setting conditions (setting information) of various kinds of information that are set in the information processing apparatus 10 or indicate the state of resources (e.g., the remaining memory capacity) in the information processing apparatus 10. The instruction information included in the help screen is information for executing a process of changing the status of the information processing apparatus 10 to solve a problem with the information processing apparatus 10 (e.g., an error that has occurred). The instruction information is, for example, an icon displayed in the help screen in such a manner that the selection of a predetermined help item is enabled.

The information processing apparatus 10 is merely required to receive a user input operation for the instruction information included in the help screen to change the status of the information processing apparatus 10. Thus, the user is able to collectively solve problems through the displayed help screen without performing a time-consuming operation to search for (or retrieve) a setting screen from multiple menu options of the information processing apparatus 10.

The help server 50 provides help information pertaining to the operation of the information processing apparatus 10 to the information processing apparatus 10 in accordance with the help request information 30 transmitted from the information processing apparatus 10. The help server 50 selects help content 63 (described below), which is likely to be useful for the user, from a help data table 60 described below in accordance with the device information 31 and the display screen information 32 included in the help request information 30, and generates help screen information 35 (described below) indicating a help screen to be displayed on the information processing apparatus 10.

In addition to providing fixed help information that is based on a device type, the help server 50 predicts a problem for the user in accordance with the display screen of the information processing apparatus 10 or in accordance with the use state of the provided help information. Then, the help server 50 provides a help screen including instruction information for solving the problem to the information processing apparatus 10. This allows the help server 50 to identify a more specific cause of the problem for the user and to provide help information indicating a more beneficial solution including instruction information for allowing the user to directly solve the problem.

The information processing apparatus 10 is, for example, an image forming apparatus such as a multifunction peripheral that implements a plurality of functions, such as a printing function, a copying function, a scanner function, and a facsimile function, within a single housing. The image forming apparatus may also be referred to as, instead of a multifunction peripheral, a multifunction peripheral/printer/product (MFP), or a copying machine. The information processing apparatus 10 may have one of the printing function, the copying function, the scanner function, and the facsimile function. In this case, the information processing apparatus 10 is referred to as a printer, a copying machine, a scanner device, or a facsimile device. One or more applications are installed in the information processing apparatus 10 to execute each function. In FIG. 1, the help information providing system includes a single information processing apparatus 10, by way of example. Alternatively, the help information providing system may include a plurality of information processing apparatuses 10 having similar functions.

The information processing apparatus 10 may be any image forming apparatus having a communication function. Examples of the information processing apparatus 10 may include a projector (PJ), an interactive white board (IWB), which is a white board having an electronic blackboard function capable of intercommunication, an output device such as digital signage, a head up display (HUD) device, an industrial machine, an imaging device, a sound collecting device, a medical device, a network home electric appliance, a notebook personal computer (PC), a mobile phone, a smartphone, a tablet terminal, a game console, a personal digital assistant (PDA) device, a digital camera, a wearable PC, and a desktop PC.

The help server 50 is a server apparatus that provides help information to the information processing apparatus 10. The help server 50 stores the help data table 60, which accumulates help data for identifying the help information to be provided to the information processing apparatus 10. The help server 50 also has a Hypertext Transfer Protocol (HTTP) server function. In FIG. 1, the help information providing system includes a single help server 50, by way of example. Alternatively, a plurality of server apparatuses may implement the functions of the help server 50. For this reasons, the server apparatus may be referred to as one or more server apparatuses.

The communication terminal 90 is a communication terminal used by an administrator or a help support person of the help information providing system. Examples of the communication terminal 90 include a smartphone. The communication terminal 90 has a browser function and displays a display screen indicating the use state of help information, which is transmitted from the help server 50, on a browser. The communication terminal 90 may be a device other than a smartphone, such as a mobile phone, a tablet terminal, a wearable PC, a notebook PC, or a desktop PC.

### Hardware Configuration

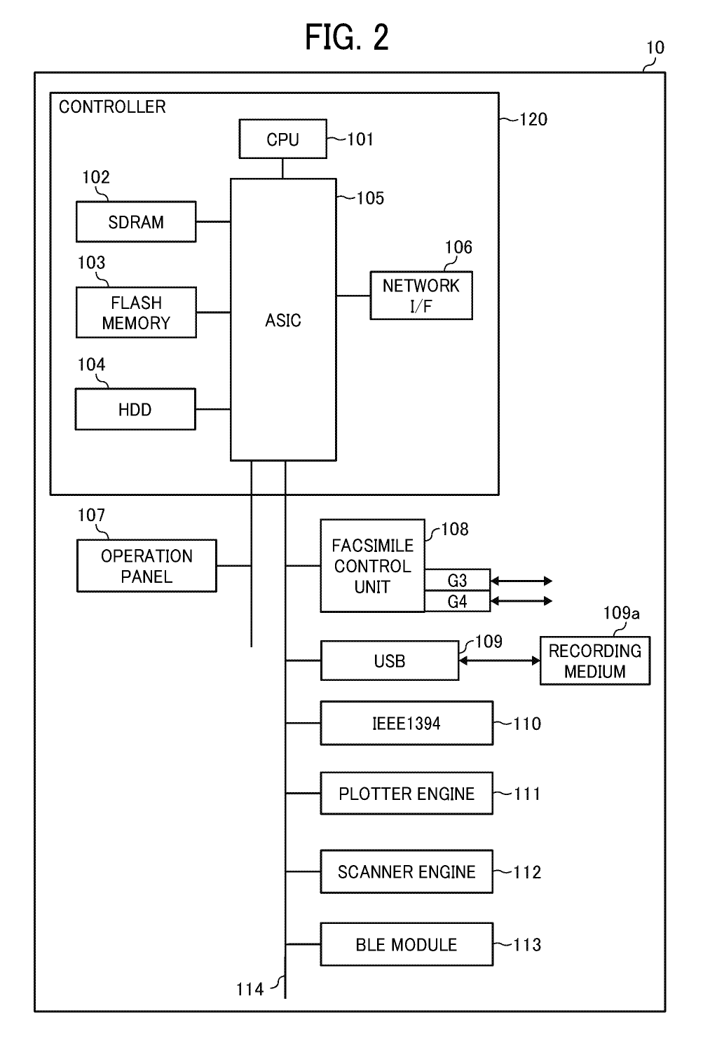

FIG. 2 illustrates an example hardware configuration of the information processing apparatus 10 according to the embodiment. A component may be added to or removed from the hardware configuration illustrated in FIG. 2, as desired. The information processing apparatus 10 includes a controller 120. The controller 120 includes a central processing unit (CPU) 101, a synchronous dynamic random access memory (SDRAM) 102, a flash memory 103, a hard disk drive (HDD) 104, an application specific integrated circuit (ASIC) 105, and a network interface (I/F) 106.

The ASIC 105 is a multi-function device board having a CPU interface, an SDRAM interface, a local bus interface, a peripheral component interconnect (PCI) bus interface, a media access controller (MAC), and an HDD interface.

The CPU 101 reads various programs from the flash memory 103 or the HDD 104 via the ASIC 105 and executes the various programs. In the help information providing system, for example, the CPU 101 of the information processing apparatus 10 executes a portion of a program according to an embodiment of the present invention to implement a help information providing method according to an embodiment of the present invention. The SDRAM 102 functions as a program memory that stores various programs, or functions as a work memory that is used when the CPU 101 executes various programs. The SDRAM 102 may be a dynamic random access memory (DRAM) or a static random access memory (SRAM).

The flash memory 103 is a non-volatile memory and stores a boot loader (boot program) for starting the information processing apparatus 10 and programs such as for an operation system (OS), a software development kit (SDK), and an application programming interface (API). Further, the flash memory 103 functions as an application memory that stores each program. The flash memory 103 further functions as a service memory that stores software for services (a copying service, a printing service, and a facsimile service).

Further, the flash memory 103 functions as a firm memory that stores firmware or functions as a data memory that stores a network address or a model and serial number. The flash memory 103 may be a non-volatile random access memory (RAM) in which a RAM and a battery backup circuit are integrated or may be any other non-volatile memory such as an electrically erasable programmable read-only memory (EEPROM).

The HDD 104 is a non-volatile storage medium that stores data regardless of whether power to the information processing apparatus 10 is turned on or off. The HDD 104 stores programs and data other than programs and data stored in the flash memory 103. The HDD 104 may be implemented as a firm memory. The network I/F 106 is an interface for performing communication (connection) via a network by using a wired LAN (Ethernet (registered trademark)) or a wireless LAN such as Wi-Fi (registered trademark). The network I/F 106 includes an antenna, a wireless unit, and a MAC unit.

An operation panel 107 is connected to the controller 120 using a Universal Serial Bus (USB) cable, for example. The operation panel 107 includes various operation keys, a character display of a liquid crystal display (LCD) or a cathode-ray tube (CRT) display serving as a display device, and a touch panel. In the information processing apparatus 10, the operation panel 107 can be operated to input data and execute and display jobs.

The controller 120 is further connected to a facsimile control unit 108, a USB port 109 to which a recording medium 109a is removably attached, an Institute of Electrical and Electronics Engineers (IEEE) 1394 port 110, a plotter engine 111, a scanner engine 112, and a Bluetooth (registered trademark) Low Energy (BLE) module 113 via a PCI bus 114. Accordingly, the information processing apparatus 10 is capable of providing services such as the copying service, the printing service, and the facsimile service. The plotter engine 111 may adopt either an electrophotographic method or an inkjet method.

The configuration illustrated in FIG. 2 is merely an example, and the hardware configuration of the information processing apparatus 10 is not limited to the configuration illustrated in FIG. 2. The network I/F 106 may be connected to the PCI bus 114, for example. Furthermore, the network I/F 106 may include a digital service unit (DSU) or a modem connectable to a telephone network. The network I/F 106 may include a communication device connectable to a mobile phone network.

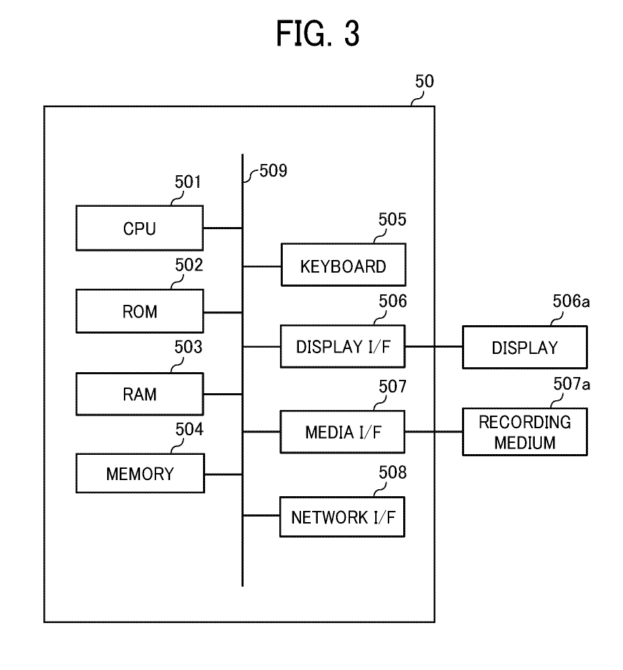

FIG. 3 illustrates an example hardware configuration of the help server 50 according to the embodiment. A component may be added to or removed from the hardware configuration illustrated in FIG. 3, as desired. While FIG. 3 illustrates the hardware configuration of the help server 50, the communication terminal 90 may have a similar configuration. The help server 50 includes a CPU 501, a read only memory (ROM) 502, a RAM 503, a memory 504, a keyboard 505, a display I/F 506, a media I/F 507, a network I/F 508, and a bus 509.

The CPU 501 controls the overall operation of the help server 50. The CPU 501 is an arithmetic unit that reads a program or data stored in the ROM 502 or the memory 504 onto the RAM 503 and executes a process to implement each function of the help server 50. In the help information providing system, for example, the CPU 501 of the help server 50 executes part or all of a program according to an embodiment of the present invention to implement a help information providing method according to an embodiment of the present invention.

The RAM 503 is a volatile memory available as a work area for the CPU 501. The ROM 502 is a non-volatile memory capable of holding programs or data even when power is turned off. The memory 504 is a storage device such as an HDD, a solid state drive (SSD), or a flash ROM and stores an OS, an application program, and various data.

The keyboard 505 is a type of input means including a plurality of keys for inputting text, numerical values, and various instructions. The input means may be a device other than the keyboard 505, such as a mouse, a touch panel, or an audio input device. The display interface I/F 506 controls the display of various kinds of information on a display 506a such as an LCD. Examples of the various kinds of information include a cursor, a menu, a window, text, and an image. The display 506a may be a touch panel display including the input means.

The media I/F 507 controls the reading or writing (storage) of data from or to a recording medium 507a such as a USB memory, a memory card, an optical disc, or a flash memory. The network I/F 508 is a communication interface that performs communication (connection) with the information processing apparatus 10 or the communication terminal 90 via the network 5. The network I/F 508 is a communication interface such as a wired or wireless LAN. The network I/F 508 may also include communication interfaces for 3rd generation (3G), Long Term Evolution (LTE), 4th generation (4G), 5th generation (5G), Zigbee (registered trademark), BLE, and millimeter-wave wireless communication.

The bus 509 is connected to the components described above to transmit an address signal, a data signal, and various control signals. The CPU 501, the ROM 502, the RAM 503, the memory 504, the keyboard 505, the display interface I/F 506, the media I/F 507, and the network I/F 508 are connected to each other via the bus 509.

### Software Configuration

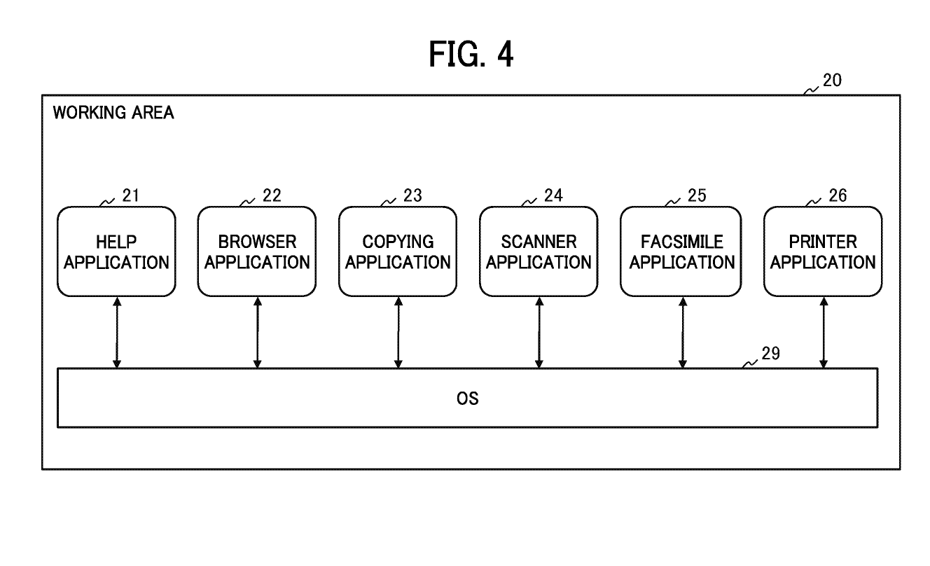

FIG. 4 illustrates an example software configuration of the information processing apparatus 10 according to the embodiment. As illustrated in FIG. 4, an OS 29, a help application 21, a browser application 22, a copying application 23, a scanner application 24, a facsimile application 25, and a printer application 26 operate in a working area 20 of the SDRAM 102. The OS 29 is basic software that provides basic functions of the information processing apparatus 10 and manages the overall operation of the information processing apparatus 10.

The help application 21 is an application for providing help information pertaining to an operation of the information processing apparatus 10. The help application 21 has a function of transmitting the help request information 30 to the help server 50. The help request information 30 includes the device information 31 for identifying the information processing apparatus 10, and the display screen information 32 indicating a display screen presented in response to a user operation for making a help request. The help application 21 also has a function of acquiring help information from the help server 50 in response to the help request. Further, the help application 21 has a function of changing the status of the information processing apparatus 10 in accordance with a user operation on the help screen displayed on the operation panel 107.

The browser application 22 is an application for causing the information processing apparatus 10 to display web content. The browser application 22 has a function of displaying a help screen provided from the help server 50 on the operation panel 107.

The copying application 23, the scanner application 24, the facsimile application 25, and the printer application 26 are applications for executing the image processing functions of the information processing apparatus 10. For example, the information processing apparatus 10 executes the copying application 23 to copy a document to be processed. Further, for example, the information processing apparatus 10 executes the scanner application 24 to scan a document to be processed.

The copying application 23, the scanner application 24, the facsimile application 25, and the printer application 26 are example applications for executing the functions of the information processing apparatus 10. The information processing apparatus 10 includes applications corresponding to the type of the information processing apparatus 10 or functions implemented by the information processing apparatus 10.

In the example illustrated in FIG. 4, the browser application 22 is installed separately from the other applications. Alternatively, any other application (e.g., the help application 21) may have the browser function.

### Functional Configuration

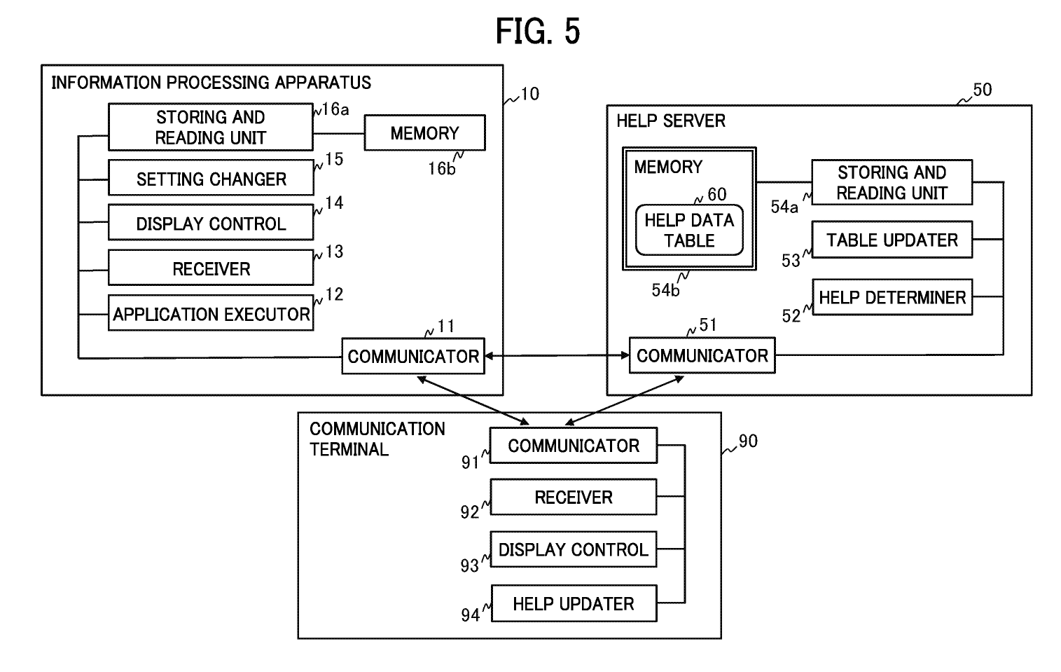

Next, the functional configuration of the help information providing system will be described. FIG. 5 illustrates an example functional configuration of the help information providing system according to the embodiment. The functions implemented by the information processing apparatus 10 illustrated in FIG. 5 include a communicator 11, an application executor 12, a receiver 13, a display control 14, a setting changer 15, a storing and reading unit 16a, and a memory 16b.

The communicator 11 is a function of exchanging data with the help server 50 and the communication terminal 90 via the network 5. For example, the communicator 11 transmits the help request information 30 to the help server 50 to request help information pertaining to an operation of the information processing apparatus 10. Further, the communicator 11 receives the help screen information 35 indicating a help screen transmitted from the help server 50.

The communicator 11 communicates with the help server 50 by using the Hypertext Transfer Protocol Secure (HTTPS) protocol, for example. The communication scheme may be based on any protocol other than HTTPS, such as File Transfer Protocol (FTP), HTTP, or Simple Mail Transfer Protocol (SMTP). The communicator 11 is implemented by, for example, the network I/F 106 and a program executed by the CPU 101 illustrated in FIG. 2.

The application executor 12 is a function of executing a process using an application installed in the information processing apparatus 10. The application executor 12 executes, for example, an application for implementing a function of the information processing apparatus 10 (e.g., the copying application 23, the scanner application 24, the facsimile application 25, or the printer application 26). For example, when the receiver 13 receives an operation of inputting a help request from the user, the application executor 12 executes the help application 21. Further, the application executor 12 executes the browser application 22 and displays a help screen provided from the help server 50 on the operation panel 107. The application executor 12 may simultaneously execute a plurality of applications. The application executor 12 is implemented by, for example, a program executed by the CPU 101 illustrated in FIG. 2.

The receiver 13 is a function of receiving an input operation performed by the user. For example, the receiver 13 receives a help request from the user through a user operation on the operation panel 107. Further, for example, the help screen received from the help server 50 is displayed by the display control 14, and the receiver 13 receives the selection of instruction information included in the displayed help screen. The receiver 13 is implemented by, for example, a program executed by the CPU 101 illustrated in FIG. 2.

The display control 14 is a function of displaying an operation screen for receiving an input operation performed by the user or a help screen received from the help server 50 on the operation panel 107 illustrated in FIG. 2. The display control 14 displays a webpage created in a hypertext markup language (HTML) on the operation panel 107 using a web browser, for example. The display control 14 is implemented by, for example, the operation panel 107 and a program executed by the CPU 101 illustrated in FIG. 2.

The setting changer 15 is a function of changing the status of the information processing apparatus 10. The setting changer 15 changes the status of the information processing apparatus 10 by, for example, selecting instruction information included in the help screen, which is help information provided from the help server 50. The status of the information processing apparatus 10 represents setting conditions of various kinds of information on the information processing apparatus 10 or the state of resources (e.g., the remaining memory capacity) in the information processing apparatus 10. The setting changer 15 is implemented by, for example, a program executed by the CPU 101 illustrated in FIG. 2.

The storing and reading unit 16a is a function of storing various data in the memory 16b and reading various data from the memory 16b. The memory 16b stores the device information 31, which is information for identifying the information processing apparatus 10, and information indicating the state of resources in the information processing apparatus 10. The storing and reading unit 16a and the memory 16b are implemented by, for example, the flash memory 103, the HDD 104, and a program executed by the CPU 101 illustrated in FIG. 2.

Next, the functional configuration of the help server 50 will be described. The functions implemented by the help server 50 include a communicator 51, a help determiner 52, a table updater 53, a storing and reading unit 54a, and a memory 54b.

The communicator 51 is a function of exchanging data with the information processing apparatus 10 and the communication terminal 90 via the network 5. For example, the communicator 51 receives the help request information 30 from the information processing apparatus 10 via the network 5. Further, for example, the communicator 51 transmits help information pertaining to an operation of the information processing apparatus 10 to the information processing apparatus 10 in response to the received help request information 30. Further, for example, the communicator 51 transmits help use state reference screen information 80 (described below) indicating the use state of help information to the communication terminal 90. The communicator 51 is implemented by, for example, the network I/F 508 and a program executed by the CPU 501 illustrated in FIG. 3. The communicator 51 is an example of acquisition means and transmission means.

The help determiner 52 is a function of selecting the help content 63 to be provided to the user in accordance with the help request information 30 transmitted from the information processing apparatus 10 and generating the help screen information 35 indicating a help screen to be displayed on the information processing apparatus 10. The help determiner 52 identifies help information to be provided to the user by using the device information 31 and the display screen information 32 included in the help request information 30. The help determiner 52 uses the help data table 60, described below, to identify the help information. The details of the process performed by the help determiner 52 will be described below. The help determiner 52 is implemented by, for example, a program executed by the CPU 501 illustrated in FIG. 3. The help determiner 52 is an example of generation means.

The table updater 53 is a function of updating the help data table 60, described below, in accordance with a request from the communication terminal 90 used by the system administrator or the help support person. The table updater 53 is implemented by, for example, a program executed by the CPU 501 illustrated in FIG. 3.

The storing and reading unit 54a is a function of storing various data in the memory 54b and reading various data from the memory 54b. The storing and reading unit 54a and the memory 54b are implemented by, for example, the ROM 502, the memory 504, and a program executed by the CPU 501 illustrated in FIG. 3. The memory 54b stores the help data table 60.

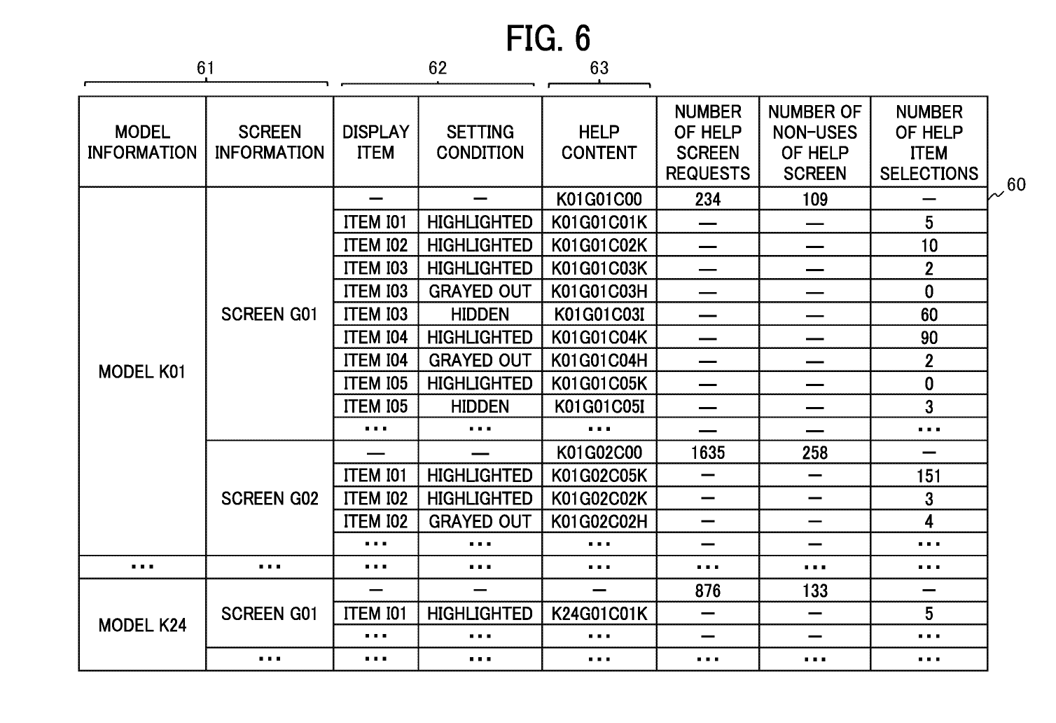

The help data table 60 stored in the memory 54b will now be described. FIG. 6 illustrates an example of the help data table 60 according to the embodiment. The help data table 60 illustrated in FIG. 6 includes help data for providing help information to the information processing apparatus 10. The help server 50 uses the help data table 60 illustrated in FIG. 6 to select the help content 63 to be provided to the information processing apparatus 10, and generates the help screen information 35 based on the selected help content 63.

The help data table 60 includes a plurality of help target items for selecting the help content 63. In the help data included in the help data table 60, a piece of help content 63 is associated with (or related to or mapped to) items indicating model information, screen information, a display item, and a setting condition. The model information and the screen information are first help target items 61, and the display item and the setting information are second help target items 62.

The model information is an item indicating the model of the information processing apparatus 10. The screen information is an item indicating the display screen of the information processing apparatus 10 that has transmitted the help request. For example, the screen information “Screen G01” illustrated in FIG. 6 indicates a home screen of an application executed on the information processing apparatus 10. Screen information “Screen G02” indicates an address book search screen.

The display item and the setting condition are items indicating the display conditions of a display screen displayed on the information processing apparatus 10. The display item and the setting condition illustrated in FIG. 6 indicate that, for example, a portion of the display screen corresponding to the name of the display item is “Highlighted”, “Grayed out”, or “hidden”.

The help content 63 is content information used to generate the help screen information 35 indicating a help screen to be displayed on the information processing apparatus 10. In the help data table 60 illustrated in FIG. 6, the help content 63 provided in the first row among rows associated with each piece of screen information is content information for displaying the layout of an outer frame of the entire help screen displayed on the information processing apparatus 10. The help content 63 provided in the rows other than the first row associated with each piece of screen information is content information that constitutes a portion of a webpage, such as in HTML, JavaScript (registered trademark), or Cascading Style Sheets (CSS).

Further, the help data table 60 illustrated in FIG. 6 stores, for each piece of help content 63, the number of times a help screen including the piece of help content 63 has been requested (the number of help screen requests), the number of times the piece of help content 63 has not been used (the number of non-uses of help screen), and the number of times the piece of help content 63 has been used (the number of help item selections).

The help determiner 52 chooses items corresponding to the device information 31 and the display screen information 32 included in the help request information 30 from the first help target items 61 and the second help target items 62 in the help data table 60 and selects the corresponding pieces of help content 63. Then, the help determiner 52 creates help screens in order from the most frequently used piece of help content 63 (from the largest number of help item selections) among the selected pieces of help content 63 to generate the help screen information 35 to be provided to the information processing apparatus 10. Accordingly, the help server 50 generates the help screen information 35 by preferentially using a frequently used piece of help content 63, resulting in it being more likely that the time taken for the user to solve a problem will be shortened.

The help data included in the help data table 60 can be corrected or changed by the administrator or the support person of the help information providing system, and the content is updated at any desired time to provide beneficial help information to the user. The help determiner 52 may select a plurality of pieces of help content 63, instead of a single piece of help content 63. Further, the help data table 60 may be provided for each application. Moreover, the same help content 63 may be used for the screen information or the settings that are common to a plurality of applications. For example, the help content “K01G01C05K” illustrated in FIG. 6 is content information that can be used in common for different models or screens.

Referring back to FIG. 5, the functional configuration of the communication terminal 90 will be described. The functions implemented by the communication terminal 90 illustrated in FIG. 5 include a communicator 91, a receiver 92, a display control 93, and a help updater 94.

The communicator 91 is a function of exchanging data with the information processing apparatus 10 or the help server 50 via the network 5. For example, the communicator 91 receives the help use state reference screen information 80 indicating the use state of help information from the help server 50. Further, for example, the communicator 91 transmits help data updated by the help updater 94 to the help server 50. The communicator 91 is implemented by, for example, the network I/F 508 and a program executed by the CPU 501 illustrated in FIG. 3.

The receiver 92 is a function of receiving an input operation performed by the user. For example, the help use state reference screen information 80 received from the help server 50 is displayed by the display control 93, and the receiver 92 receives a user input operation performed on a displayed help use state confirmation screen. The receiver 92 is implemented by, for example, a program executed by the CPU 501 illustrated in FIG. 3.

The display control 93 is a function of causing the display 506a illustrated in FIG. 3 to display an operation screen for receiving an input operation performed by the user or a help use state reference screen received from the help server 50. The display control 93 displays a webpage created in a HTML on the display 506a using a web browser, for example. The display control 93 is implemented by, for example, the display interface I/F 506 and a program executed by the CPU 501 illustrated in FIG. 3.

The help updater 94 is a function of updating the help data table 60 stored in the help server 50. For example, the help updater 94 updates (generates or corrects) the help data included in the help data table 60 in accordance with a user operation. The communication terminal 90 transmits the generated or corrected help data to the help server 50. The help updater 94 is implemented by, for example, a program executed by the CPU 501 illustrated in FIG. 3.

### Process for Providing Help Information

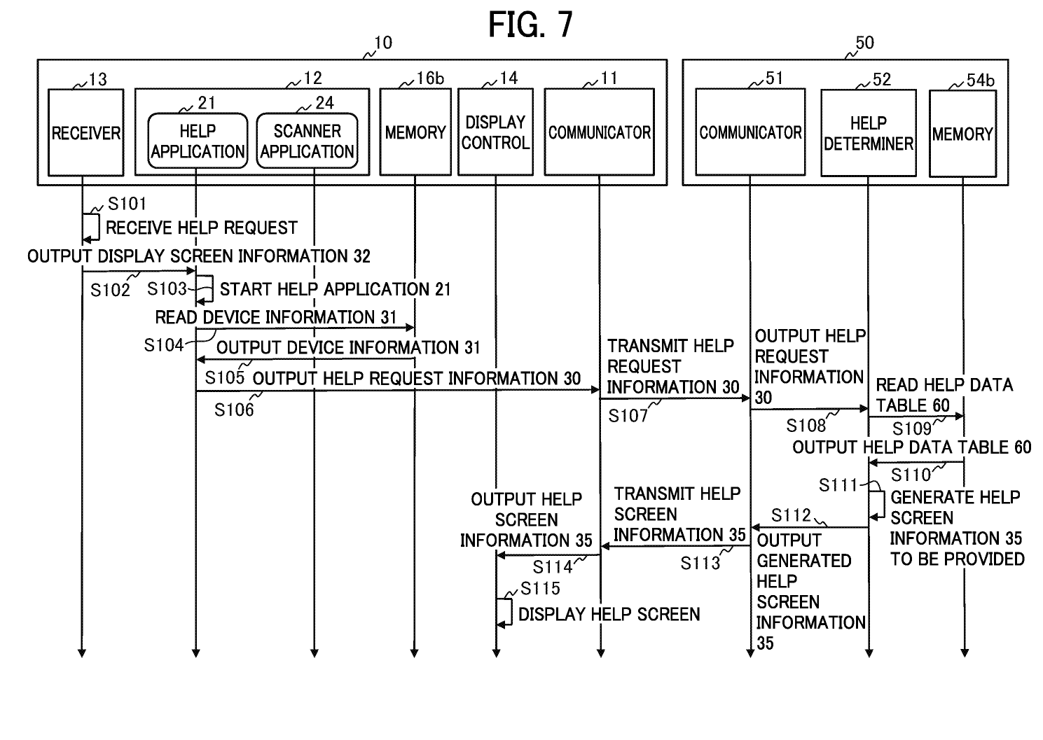

Next, a help information providing method performed in the help information providing system will be described. FIG. 7 is a sequence diagram illustrating an exemplary process performed in the help information providing system according to the embodiment for displaying a help screen on the information processing apparatus 10. In FIG. 7, the scanner application 24 is operating on the information processing apparatus 10. In the process illustrated in FIG. 7, any other application (e.g., the copying application 23) for implementing another of the functions of the information processing apparatus 10 illustrated in FIG. 4 may be operating on the information processing apparatus 10. In FIG. 7, the help application 21 and the scanner application 24 have the browser function.

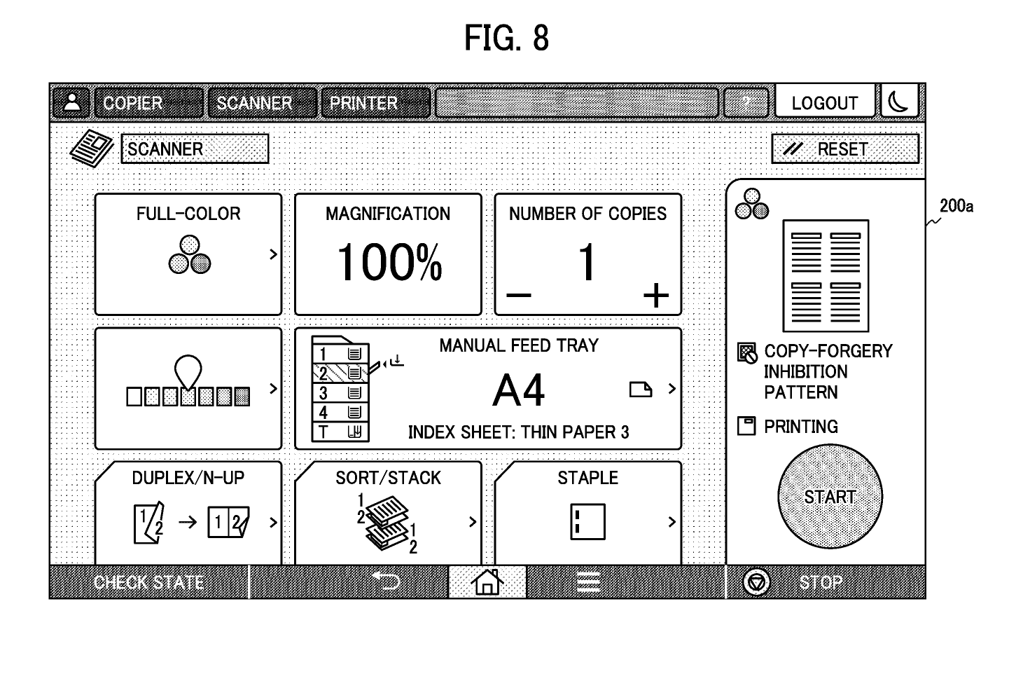

In step S101, the receiver 13 of the information processing apparatus 10 receives a request for help information through a user input operation performed on the operation panel 107. FIG. 8 illustrates an example display screen displayed on the information processing apparatus 10 according to the embodiment before a help request is made. The information processing apparatus 10 displays a display screen 200a for the scanner application 24. For example, if the user encounters a problem such as not knowing how to operate the information processing apparatus 10 when the display screen 200a illustrated in FIG. 8 is being displayed on the operation panel 107, the user selects a help icon (with a question mark “?” in an upper right portion of the display screen 200a) to request help information.

In step S102, the receiver 13 outputs the display screen information 32 to the application executor 12. The display screen information 32 to be output is information indicating a display screen displayed on the operation panel 107 when the help icon is selected. For example, when the help icon on the display screen 200a illustrated in FIG. 8 is selected, the display screen information 32 indicates information on the display screen 200a.

In step S103, the application executor 12 starts the help application 21 when the help request information 30 output from the receiver 13 is detected. In step S104, the help application 21 reads the device information 31 stored in the memory 16b. Specifically, the started help application 21 outputs a request for reading the device information 31 to the storing and reading unit 16a. When the output request is detected, the storing and reading unit 16a reads the device information 31 stored in the memory 16b.

In step S105, the memory 16b outputs the device information 31 to the help application 21. Specifically, the memory 16b outputs the device information 31 to the storing and reading unit 16a. Then, the storing and reading unit 16a outputs the output device information 31 to the help application 21 executed by the application executor 12.

In step S106, the help application 21 executed by the application executor 12 outputs the help request information 30 to the communicator 11. The help request information 30 includes the read device information 31 and the display screen information 32 output from the receiver 13. In step S107, the communicator 11 of the information processing apparatus 10 transmits the help request information 30 output from the help application 21 to the help server 50 (exemplary acquisition step).

In step S108, the communicator 51 of the help server 50 outputs the received help request information 30 to the help determiner 52. In step S109, the help determiner 52 reads the help data table 60 stored in the memory 54b when the help request information 30 output from the communicator 51 is detected. Specifically, the help determiner 52 outputs a request for reading the help data table 60 to the storing and reading unit 54a. Then, when the output request is detected, the storing and reading unit 54a reads the help data table 60 stored in the memory 54b.

In step S110, the memory 54b outputs the help data table 60 to the help determiner 52. Specifically, the memory 54b outputs the help data table 60 to the storing and reading unit 54a. Then, the storing and reading unit 54a outputs the output help data table 60 to the help determiner 52. In step S111, the help determiner 52 generates the help screen information 35 to be provided to the information processing apparatus 10 (exemplary generation step).

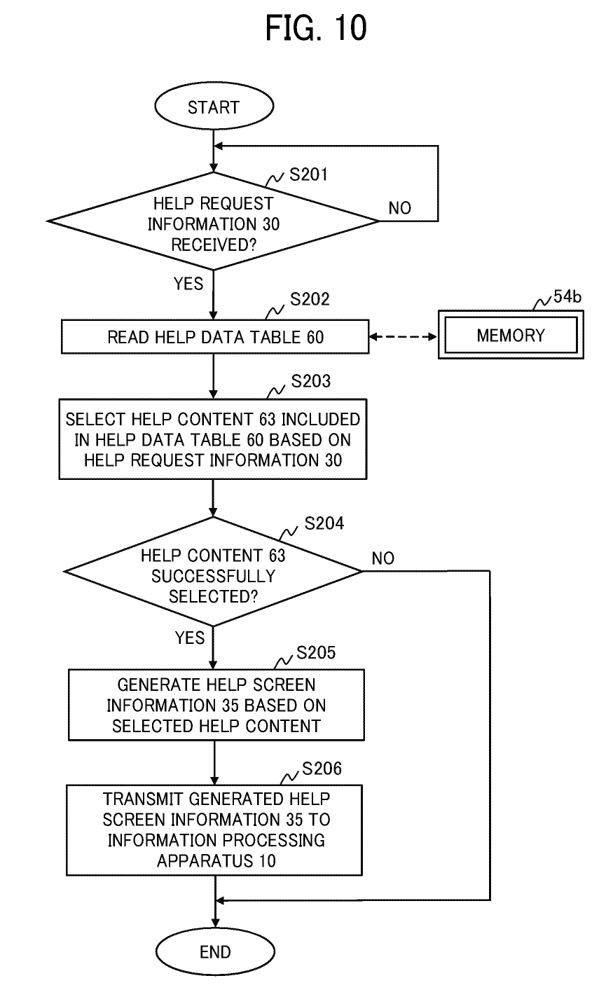

The details of the process performed by the help server 50, which has acquired the help request information 30 from the information processing apparatus 10, will now be described. FIG. 10 is a flowchart illustrating an exemplary process performed by the help server 50 according to the embodiment. In the process illustrated in FIG. 10, the memory 54b of the help server 50 is assumed to store the help data table 60 illustrated in FIG. 6.

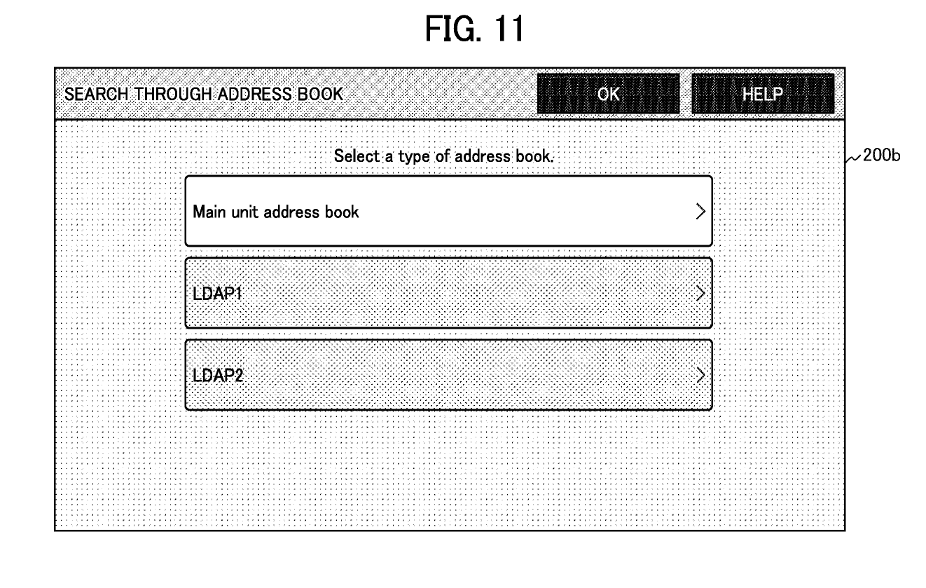

Further, it is assumed that the help request information 30 illustrated in FIG. 10 includes a display screen 200b illustrated in FIG. 11 as the display screen information 32. FIG. 11 illustrates an example display screen displayed on the information processing apparatus 10 according to the embodiment before a help request is made. The display screen 200b illustrated in FIG. 11 is a screen for selecting an address book to be searched in the information processing apparatus 10. The process illustrated in FIG. 10 is a process performed when, for example, the selection of Lightweight Directory Access Protocol (LDAP) servers on the display screen 200b illustrated in FIG. 11, from which the user of the information processing apparatus 10 desires to perform an address search, is disabled since the text representing them is displayed as grayed out. The user of the information processing apparatus 10 selects a help icon in an upper right portion of the display screen 200b illustrated in FIG. 11 to transmit a help request to the help server 50.

If the communicator 51 receives the help request information 30 in step S201 (exemplary acquisition step), the help server 50 causes the process to proceed to step S202. On the other hand, if the help request information 30 is not received, the help server 50 repeatedly performs the processing of step S201.

In step S202, the help determiner 52 of the help server 50 reads the help data table 60 from the memory 54b. In step S203, the help determiner 52 selects, based on the read help data table 60 and the received help request information 30, the help content to be provided to the information processing apparatus 10.

Specifically, the help determiner 52 selects items corresponding to the device information 31 and the display screen information 32 included in the help request information 30 from among the first help target items 61 in the help data table 60 illustrated in FIG. 6. For example, the device information 31 included in the help request information 30 indicates “K01”, and the display screen information 32 indicates a screen for selecting an address book to be searched. In this case, the help determiner 52 selects help content “K01G02C00”, which is associated with (or related to or mapped to) the model information “Model K01” and the screen information “Screen G02” in the first help target items 61.

Then, the help determiner 52 selects items corresponding to resource information included in the display screen information 32 from among the second help target items 62 in the help data table 60 illustrated in FIG. 6. In the help data table 60 illustrated in FIG. 6, “Item I01” corresponds to “Main unit address book”, and “Item I02” corresponds to “LDAP”. As illustrated in FIG. 11, the display screen 200b included in the display screen information 32 indicates that the main unit address book is highlighted and LDAP is grayed out. When the main unit address book is highlighted, address search using the main unit address book is enabled in the information processing apparatus 10. When LDAP is grayed out, address search using LDAP is disabled in the information processing apparatus 10.

In this case, the help determiner 52 selects the help content “K01G02C05K”, which is associated with (or mapped to or related to) the display item “Item I01” and the setting condition “Highlighted”, and the help content “K01G02C02H”, which is associated with the display item “Item I02” and the setting condition “Grayed out”. While FIG. 10 illustrates a process performed when three pieces of help content 63 are selected, any other number of pieces of help content may be selected. For example, a single piece of help content may be selected.

If help content is successfully selected in step S204, the help determiner 52 causes the process to proceed to step S205. On the other hand, if help content is not successfully selected, the help determiner 52 ends the process.

In step S205, the help determiner 52 generates the help screen information 35, which is a help screen to be displayed on the information processing apparatus 10, based on the selected help content. Specifically, as in step S203, the help determiner 52 generates the help screen information 35 by using the selected pieces of help content “K01G02C00”, “K01G02C05K”, and “K01G02C02H”. The processing of steps S203 to S205 is an exemplary generation step. In step S206, the communicator 51 of the help server 50 transmits the help screen information 35 generated by the help determiner 52 to the information processing apparatus 10 (exemplary transmission step).

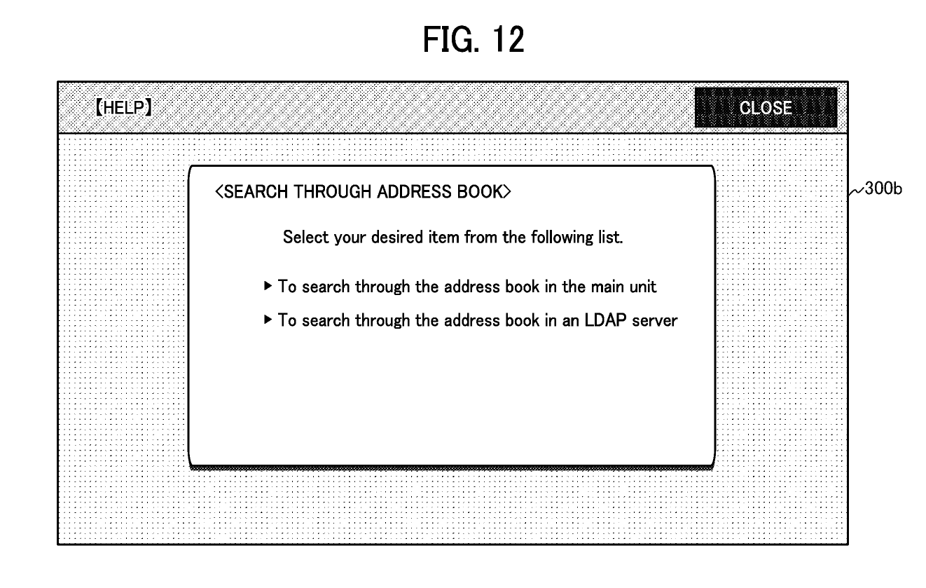

The help screen information 35 generated using the process illustrated in FIG. 10 will now be described. FIG. 12 illustrates an example of a help screen initially displayed on the information processing apparatus 10 according to the embodiment. The help item “To search through the address book in the main unit” illustrated in FIG. 12 is generated based on the help content “K01G02C05K” corresponding to the display item “Main unit address book” and the setting condition “Highlighted” illustrated in FIG. 6. The help item “To search through the address book in an LDAP server” illustrated in FIG. 12 is generated based on the help content “K01G02C02H” corresponding to the display item “LDAP” and setting condition “Grayed out” illustrated in FIG. 6.

A help screen 300b illustrated in FIG. 12 is a help screen generated (or formed) using the pieces of help content “K01G02C05K” and “K01G02C02H” and the help content “K01G02C00” for generating an outer frame of the entire help screen. The help server 50 transmits the generated help screen 300b to the information processing apparatus 10 as the help screen information 35.

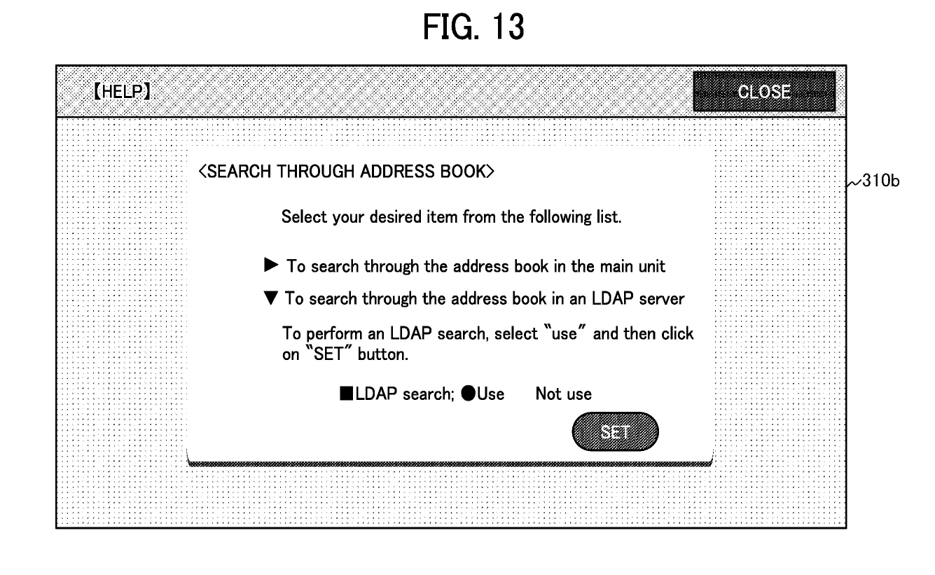

FIG. 13 illustrates an example of a help screen on the information processing apparatus 10 according to the embodiment after a help item is selected. A help screen 310b illustrated in FIG. 13 is displayed on the information processing apparatus 10 in response to the selection of the help item “To search through the address book in an LDAP server” on the help screen 300b illustrated in FIG. 12. The help screen 310b illustrated in FIG. 13 presents a help item for promoting settings to enable an LDAP search.

The help server 50 acquires the setting conditions of the information processing apparatus 10 to identify the reason that the selection of LDAP servers is disabled on the display screen of the information processing apparatus 10. The setting conditions of the information processing apparatus 10 are transmitted to the help server 50 as the display screen information 32 included in the help request information 30. Further, the help content 63 contains information such as whether to change the settings or which help item to switch to. In FIG. 13, the help content “K01G02C02H” contains, for example, a help item presented on the help screen 310b to promote settings to enable an LDAP search.

If the help item “To search through the address book in an LDAP server” is selected on the help screen 300b illustrated in FIG. 12, the information processing apparatus 10 transmits help selection information 40 indicating the use of the help content “K01G02C02H” to the help server 50. The help server 50 counts the number of times help has been selected for the items corresponding to the help target items “Model information→Screen information→Display item→Grayed out” in the help data table 60 illustrated in FIG. 6.

The help server 50 generates the help screen information 35 by preferentially using the help content 63 corresponding to a help item selected by more users on the help screen 300b illustrated in FIG. 12. In the help data table 60 illustrated in FIG. 6, the number of help item selections for the item corresponding to “Model K01/Screen G02/Item I01/Highlighted” is larger than that for the item corresponding to “Model K01/Screen G02/Item I02/Grayed out”. Accordingly, the help item “To search through the address book in the main unit”, which corresponds to “Model K01/Screen G02/Item I01/Highlighted”, is presented at a higher position on the help screen 300b illustrated in FIG. 12. A help item associated with a large number of help item selections may be displayed on a help screen in any other fashion. For example, a help item associated with a large number of help item selections may be displayed with a changed character size or font.

When the receiver 13 receives the selection of a “SET” icon on the help screen 310b illustrated in FIG. 13, the information processing apparatus 10 reflects a change in the settings of the information processing apparatus 10. Then, the information processing apparatus 10 closes the help screen 310b. In the case of the help screen 310b illustrated in FIG. 13, the information processing apparatus 10 changes setting information of the information processing apparatus 10 so as to enable address search using an LDAP server. The help items displayed on the help screen 300b illustrated in FIG. 12 and the help screen 310b illustrated in FIG. 13 are examples of instruction information for changing the status of the information processing apparatus 10.

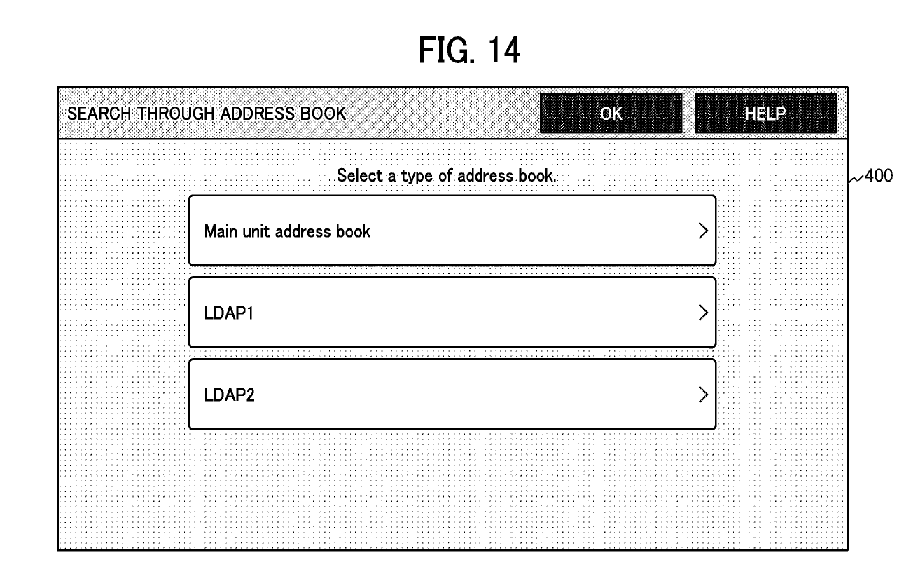

FIG. 14 illustrates an example display screen immediately after the help screen is closed after the settings of the information processing apparatus 10 according to the embodiment are changed. A display screen 400 illustrated in FIG. 14, which is presented after the settings are changed, is obtained as a result of enabling an LDAP search in the help screen illustrated in FIG. 12 and FIG. 13 to update the display screen. On the display screen 400 illustrated in FIG. 14, unlike the display screen 200b illustrated in FIG. 11, selection of an LDAP search is enabled. In this way, the information processing apparatus 10 is capable of changing setting information of the information processing apparatus 10 by selecting a help item on a help screen provided from the help server 50.

Referring back to FIG. 7, the description of the help information providing method performed in the help information providing system continues. In step S112, the help determiner 52 outputs the generated help screen information 35 to the communicator 51. In step S113, the communicator 51 transmits the help screen information 35 output from the help determiner 52 to the information processing apparatus 10 (exemplary transmission step). In step S114, the communicator 11 outputs the received help screen information 35 to the display control 14.

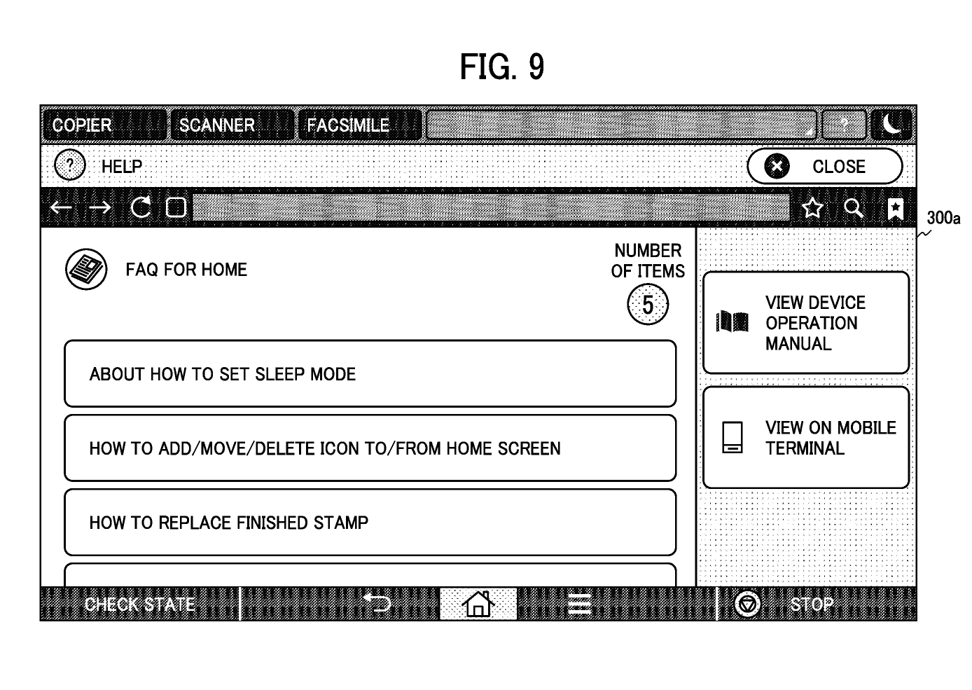

In step S115, the display control 14 displays a help screen included in the help screen information 35 output from the communicator 11 on the operation panel 107. As illustrated in the processing of step S101 described above, when the help request information 30 is transmitted while the display screen 200a illustrated in FIG. 8 is displayed on the operation panel 107, the display control 14 displays a help screen 300a illustrated in FIG. 9 on the operation panel 107.

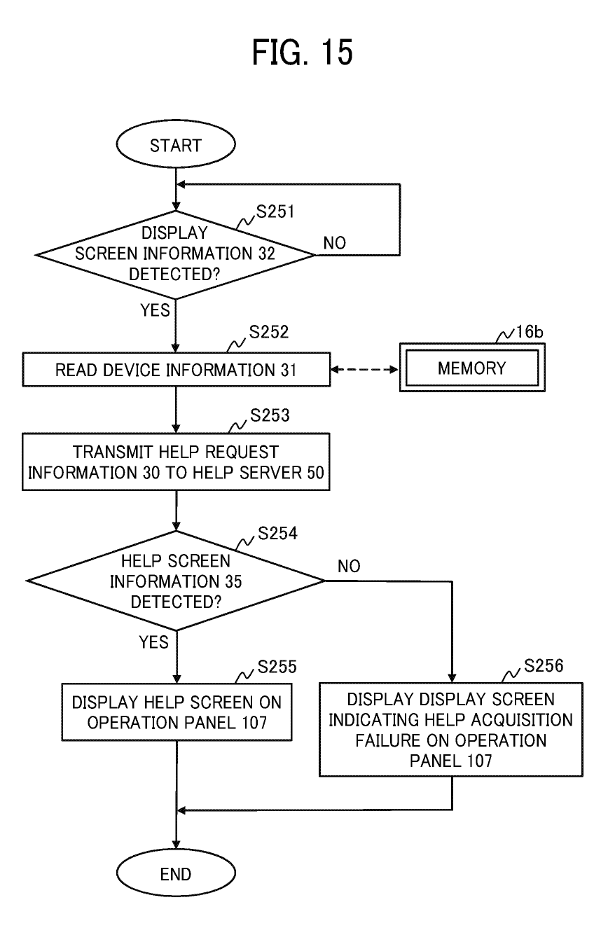

Next, a process for the help application 21 executed by the application executor 12 will be described. FIG. 15 is a flowchart illustrating an exemplary process for the help application 21 in the information processing apparatus 10 according to the embodiment. If the display screen information 32 is detected in step S251, the help application 21 causes the process to proceed to step S252. On the other hand, if the display screen information 32 is not detected, the help application 21 repeatedly performs the processing of step S251.

In step S252, the help application 21 reads the device information 31 from the memory 16b. In step S253, the help application 21 transmits the help request information 30 including the device information 31 and the display screen information 32 to the help server 50. Specifically, the help application 21 outputs the help request information 30 to the communicator 11. Then, the communicator 11 transmits the output help request information 30 to the help server 50.

If the help screen information 35 transmitted from the help server 50 is detected in step S254, the help application 21 causes the process to proceed to step S255. In step S255, the help application 21 displays a help screen indicated by the detected help screen information 35 on the operation panel 107. Specifically, the help application 21 outputs the detected help screen information 35 to the display control 14. Then, the display control 14 displays a help screen on the operation panel 107 in accordance with the help screen information 35 output from the help application 21.

On the other hand, if the help screen information 35 transmitted from the help server 50 is not detected in step S254, the help application 21 causes the process to proceed to step S256. For example, when a message indicating that the acquisition of help information is not successful (help acquisition failure) is received from the help server 50, the help application 21 determines that the help screen information 35 is not detected.

In step S256, the help application 21 displays a display screen indicating help acquisition failure, which is stored in the information processing apparatus 10 in advance, on the operation panel 107. This allows the help information providing system to present, for example, the cause of unsuccessful acquisition of help information to the user in a separate manner from other causes such as a cause of unsuccessful communication with the help server 50 due to failure in the network 5. For example, if a certain amount of time elapses after the help request information 30 is transmitted to the help server 50, the help application 21 may determine that the help screen information 35 is not detected.

### Process after Display of Help Screen

### Process when Help Information is Used

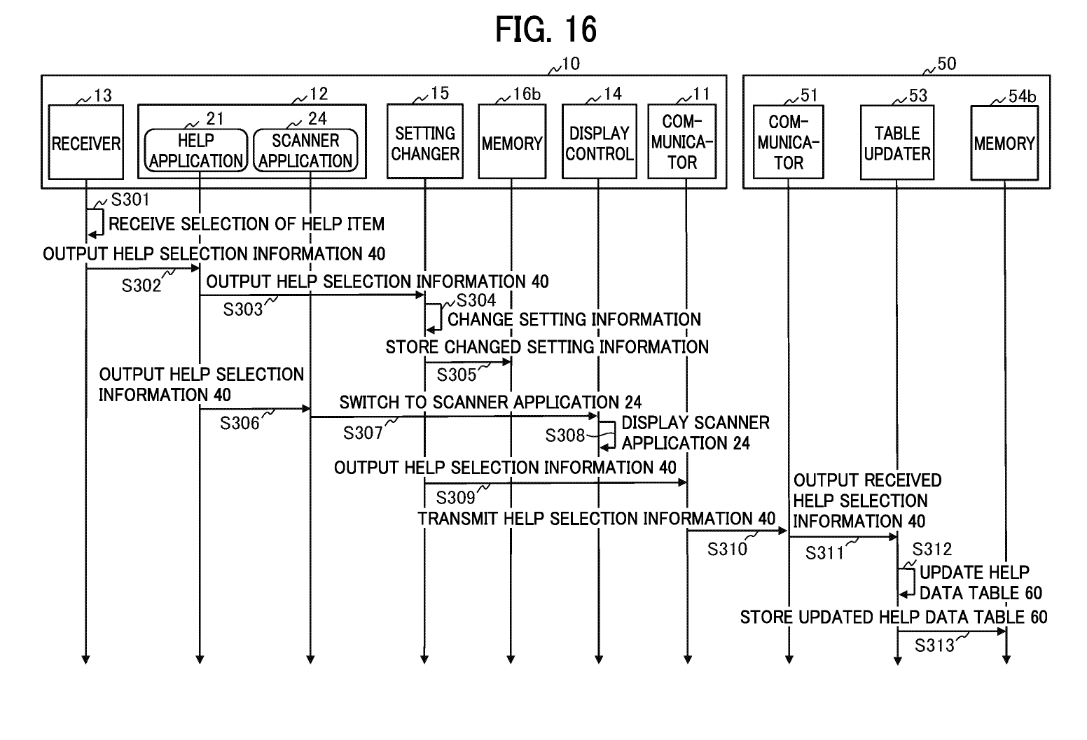

Next, a process performed when help information provided from the help server 50 is used in the information processing apparatus 10 will be described. FIG. 16 is a sequence diagram illustrating an exemplary process performed in the help information providing system according to the embodiment when help information is used. In FIG. 16, the help screen 300b illustrated in FIG. 12 and the help screen 310b illustrated in FIG. 13 are being displayed on the information processing apparatus 10. In FIG. 16, as in the process illustrated in FIG. 7, the help application 21 and the scanner application 24 have the browser function.

In step S301, the receiver 13 of the information processing apparatus 10 receives the selection of a help item on a help screen displayed on the operation panel 107. In step S302, the receiver 13 outputs the help selection information 40 indicating the selection of a help item to the help application 21 executed by the application executor 12. The help selection information 40 includes information on the selected help item.

In step S303, the help application 21 outputs the detected help selection information 40 to the setting changer 15. In step S304, based on the help item included in the detected help selection information 40, the setting changer 15 changes the settings of the information processing apparatus 10. In the case of the help screen 310b illustrated in FIG. 13, the setting changer 15 changes the setting information of the information processing apparatus 10 so as to enable address search using an LDAP server. In step S305, the setting changer 15 stores the changed setting information in the memory 16b.

In the process illustrated in FIG. 16, the help information providing system may not necessarily acquire the settings of the information processing apparatus 10 from the help server 50. This eliminates the need for the information processing apparatus 10 to, for example, acquire or write the content of the settings from the help server 50, which is located in a network, via a firewall, reducing security risks such as information leakage.

In step S306, the help application 21 outputs the help selection information 40 output from the receiver 13 to the scanner application 24 executed by the application executor 12. In step S307, the scanner application 24 updates display screen information of the scanner application 24 when the help selection information 40 is detected. Then, the display control 14 switches the display on the browser, which is a display screen displayed on the operation panel 107, to the scanner application 24. In step S308, the display control 14 displays the scanner application 24 executed by the application executor 12 on the operation panel 107.

In step S309, the setting changer 15 outputs the help selection information 40 to the communicator 11. In step S310, the communicator 11 of the information processing apparatus 10 transmits the help selection information 40 to the help server 50. In step S311, the communicator 51 of the help server 50 outputs the received help selection information 40 to the table updater 53.

In step S312, the table updater 53 updates the help data table 60 when the help selection information 40 output from the communicator 51 is detected. Since the help information provided from the help server 50 is used, the table updater 53 counts the number of help item selections for the used help item in the help data table 60. For example, a help item on the help screen 310b is selected. In this case, the table updater 53 counts the number of help item selections for the help content “K01G02C02H” in the help data table 60 illustrated in FIG. 6. In step S313, the table updater 53 stores the updated help data table 60 in the memory 54b.

In the process illustrated in FIG. 16, the processing of steps S303 to S305, the processing of steps S306 to S308, and the processing of steps S309 to S313 may be reordered or performed in parallel.

### Process when Help Information is Not Used

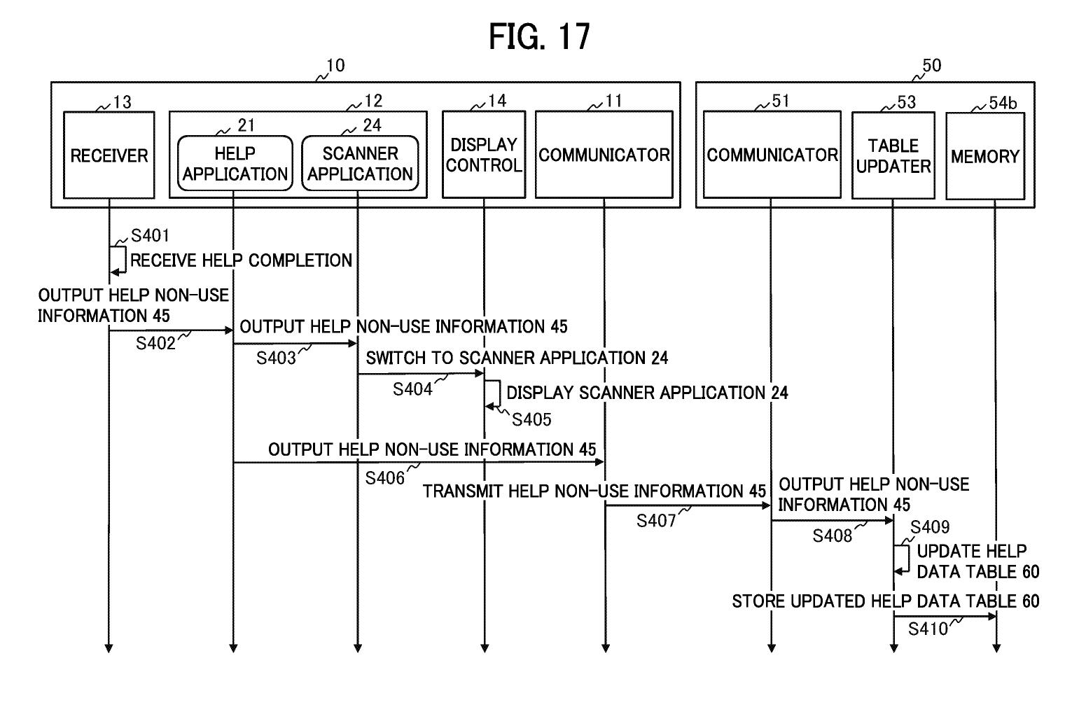

Next, a process performed when help information provided from the help server 50 is not used in the information processing apparatus 10 will be described. FIG. 17 is a sequence diagram illustrating an exemplary process performed in the help information providing system according to the embodiment when help information is not used. In FIG. 17, a process when a “CLOSE” icon is selected on the help screen 300b illustrated in FIG. 12 displayed on the information processing apparatus 10 without the selection of any help item on the help screen 300b is illustrated. In FIG. 17, furthermore, as in the process illustrated in FIG. 16, the help application 21 and the scanner application 24 have the browser function.

In step S401, the receiver 13 of the information processing apparatus 10 receives help completion through a user operation on the operation panel 107 on which the help screen 300b is displayed. Specifically, the receiver 13 receives the selection of the “CLOSE” icon on the help screen 300b. In step S402, the receiver 13 outputs help non-use information 45 indicating that help is finished without the selection of any help item to the help application 21 executed by the application executor 12. In step S403, the help application 21 outputs the help non-use information 45 output from the receiver 13 to the scanner application 24 executed by the application executor 12.

In step S404, when the help non-use information 45 is detected, the display control 14 switches the display on the browser, which is a display screen displayed on the operation panel 107, to the scanner application 24. In step S405, the display control 14 displays the scanner application 24 executed by the application executor 12 on the operation panel 107. In this case, the display screen of the scanner application 24 to be displayed on the operation panel 107 is similar to the screen obtained before the help screen is displayed since the help information is not used.

In step S406, the help application 21 outputs the help non-use information 45 output from the receiver 13 to the communicator 11. In step S407, the communicator 11 outputs the help non-use information 45 to the help server 50. In step S408, the communicator 51 of the help server 50 outputs the received help non-use information 45 to the table updater 53.

In step S409, the table updater 53 updates the help data table 60 when the help non-use information 45 output from the communicator 51 is detected. The table updater 53 determines that the help information provided from the help server 50 is likely to be useless, and counts the number of non-uses of the help screen for the unused screen information in the help data table 60. For example, no help item is selected and the “CLOSE” icon is selected on the help screen 300b illustrated in FIG. 12. In this case, the table updater 53 counts the number of non-uses of the help screen for the help content “K01G02C00” in the help data table 60 illustrated in FIG. 6. In step S410, the table updater 53 stores the updated help data table 60 in the memory 54b.

In the process illustrated in FIG. 17, the processing of steps S403 to S405 and the processing of steps S406 to S410 may be reordered or performed in parallel. As illustrated in FIG. 17, if provided help information is not used, the help information providing system stores the unused help content 63. This allows the administrator or the support person of the help information providing system to easily identify the help content 63 that is not help information beneficial to the user, efficiently updating help information to be provided.

### Process Performed in Information Processing Apparatus after Display of Help Screen

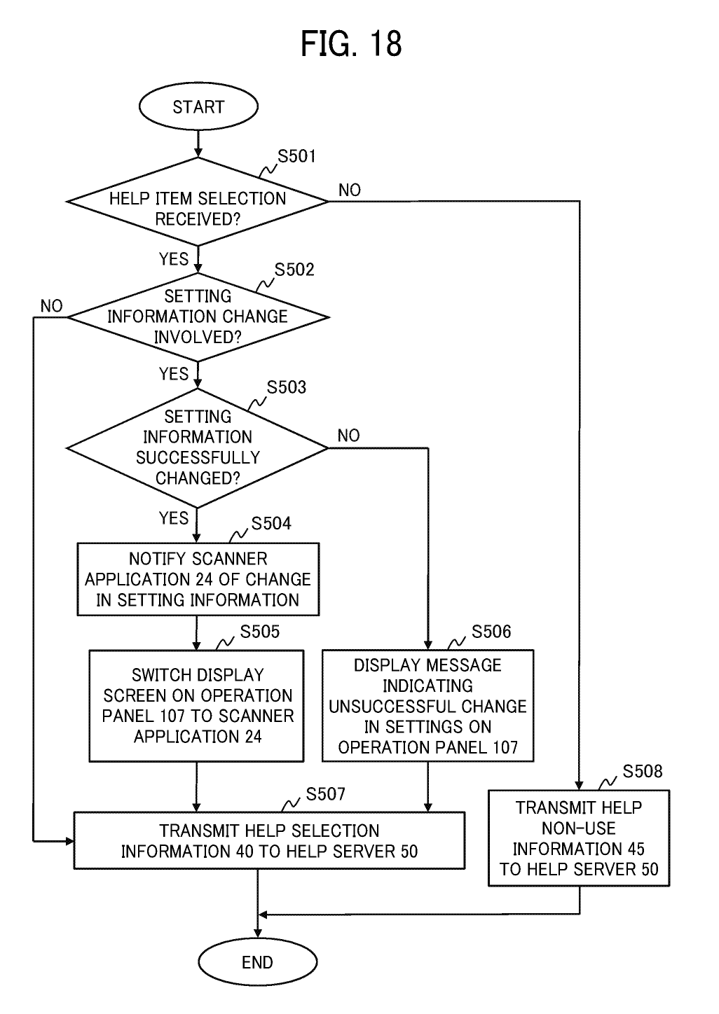

Next, a process performed by the information processing apparatus 10 after the display of a help screen will be described. FIG. 18 is a flowchart illustrating an exemplary process performed by the information processing apparatus 10 according to the embodiment after the display of a help screen.

In step S501, when the receiver 13 of the information processing apparatus 10 receives the selection of a help item, the process proceeds to step S502. On the other hand, if the receiver 13 of the information processing apparatus 10 does not receive the selection of a help item, the process proceeds to step S508. It is determined that the receiver 13 of the information processing apparatus 10 has not received the selection of a help item if the help screen is closed without the selection of any help item. It may be determined that the receiver 13 has not received the selection of a help item if no help item is selected within a certain amount of time after the help screen is displayed.

In step S508, the communicator 11 of the information processing apparatus 10 transmits the help non-use information 45 indicating non-use of help information to the help server 50, and then the process ends. In response to receipt of the help non-use information 45, the help server 50 updates the number of non-uses of the help screen for the unused screen information in the help data table 60.

In step S502, if the selection of a help item involves changing the setting information of the information processing apparatus 10, the information processing apparatus 10 causes the process to proceed to step S503. On the other hand, if the selection of a help item does not involve changing the setting information of the information processing apparatus 10, the information processing apparatus 10 causes the process to proceed to step S507.

In step S503, the setting changer 15 of the information processing apparatus 10 changes the setting information so that the settings of the information processing apparatus 10 are suitable for the selected help item. When the setting changer 15 is successful in changing the setting information, the process proceeds to step S504. In step S504, the help application 21 of the information processing apparatus 10 notifies the scanner application 24 of the change in the setting information.

In step S505, the information processing apparatus 10 switches the display on the browser, which is a display screen displayed on the operation panel 107, from the help application 21 to the scanner application 24. Specifically, when the notification of the change in the setting information, which is output from the help application 21, is detected, the scanner application 24 of the information processing apparatus 10 updates the display screen of the scanner application 24 to that in which the settings have been changed. The display control 14 switches the display screen to be displayed on the operation panel 107 to the scanner application 24. Then, the display control 14 displays the display screen of the scanner application 24 on the operation panel 107. The display screen displayed through the scanner application 24 is a screen that reflects the change in the setting information of the information processing apparatus 10 from the display screen presented when the help request was made (e.g., the display screen 200b illustrated in FIG. 11), such as the display screen 400 illustrated in FIG. 14.

On the other hand, if the setting changer 15 of the information processing apparatus 10 fails to change the setting information in step S503, the process proceeds to step S506. In step S506, the information processing apparatus 10 displays a message indicating unsuccessful change in the settings on the operation panel 107. Specifically, if the setting changer 15 fails to change the setting information, the display control 14 of the information processing apparatus 10 displays a message indicating unsuccessful change in the settings, which is stored in the memory 16b, on the operation panel 107.

In step S507, the information processing apparatus 10 transmits the help selection information 40 to the help server 50. In response to receipt of the help selection information 40, the help server 50 updates the number of help item selections for the selected help item in the help data table 60. The processing of steps S504 to S505 and the processing of step S507 may be reordered or performed in parallel.

In the processing of step S503, when the setting changer 15 changes the setting information, the information processing apparatus 10 may be capable of selecting whether the changed setting conditions are set as default. This configuration allows the user of the information processing apparatus 10 to utilize the information processing apparatus 10 in the changed setting conditions without performing an operation of searching for (or retrieving) a setting screen or help item next time.

In the processing of step S503, when the setting changer 15 changes the setting information, furthermore, the information processing apparatus 10 may store a history of changes in the setting information. This configuration allows, for example, any other user of the information processing apparatus 10 to refer to the stored history of changes which helps the user solve their problem.

### Help Data Update Process

Next, a process will be described for checking the help data accumulated in the help server 50 and the use state of the help screen on the communication terminal 90 used by a system administrator or a support person of the information processing apparatus 10.

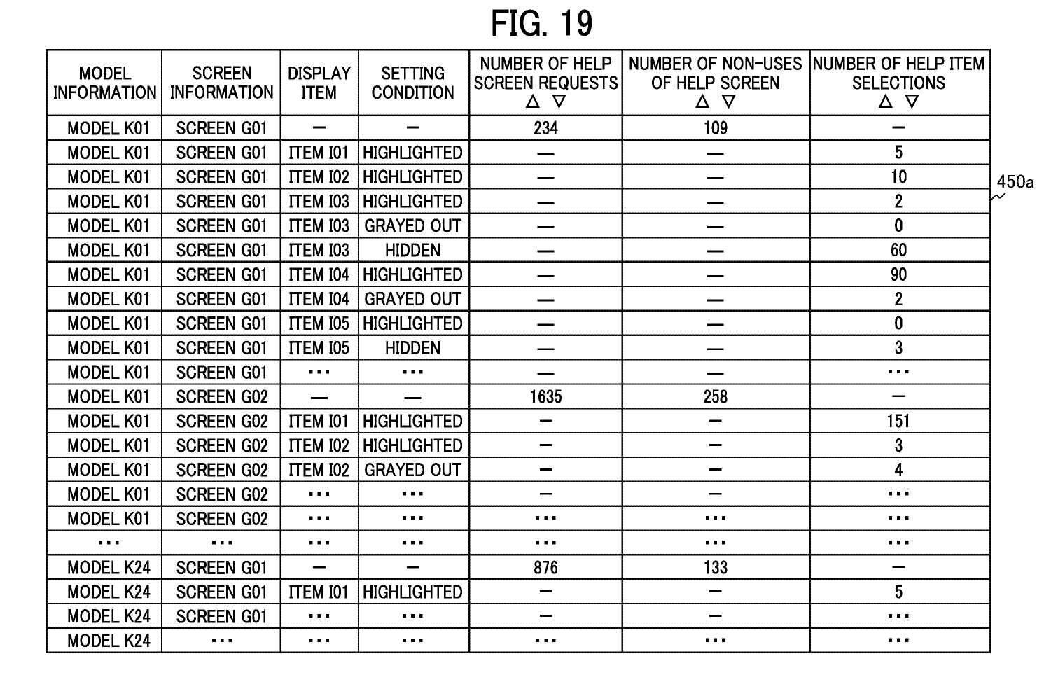

FIG. 19 illustrates an example of a help use state reference screen according to the embodiment. A help use state reference screen 450a illustrated in FIG. 19 is displayed on the display 506a by the display control 93 of the communication terminal 90. The help use state reference screen 450a presents a list view of the help data table 60 stored in the help server 50. The help server 50 transmits the help use state reference screen information 80 indicating the help use state reference screen 450a to the communication terminal 90.

The system administrator who uses the communication terminal 90 can use the help use state reference screen 450a displayed on the communication terminal 90 to analyze and update the help information provided from the help server 50. In the help use state reference screen 450a illustrated in FIG. 19, for example, an “upward or downward pointing triangle” icon in a column name can be selected to sort the pieces of corresponding help data in ascending order or descending order.

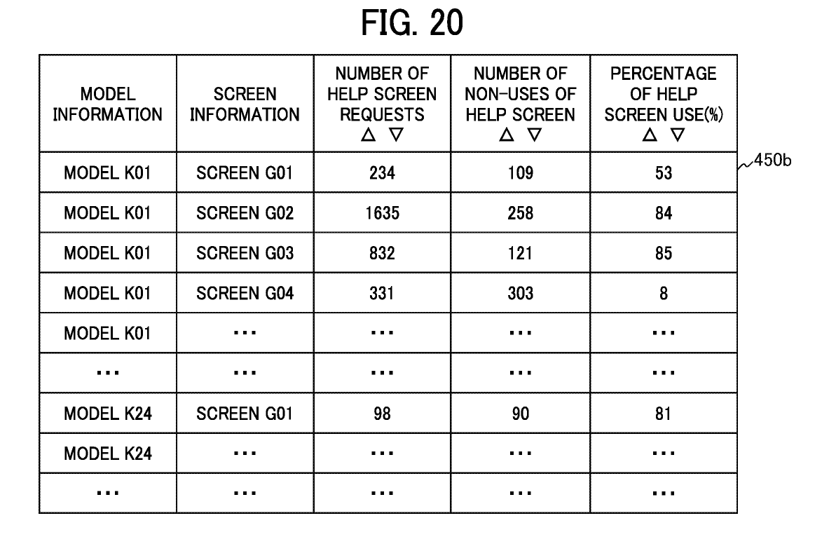

FIG. 20 illustrates another example help use state reference screen according to the embodiment. Unlike the help use state reference screen 450a illustrated in FIG. 19, a help use state reference screen 450b illustrated in FIG. 20 is an example screen for checking (or analyzing) the use state of the help screen for each piece of screen information. In the help use state reference screen 450b, furthermore, in place of the number of help item selections, the percentage of help screen use is mapped to each piece of help data. The help use state reference screen 450b illustrated in FIG. 20 indicates that the help data for the screen information “Screen G04” with a low percentage of help screen use includes content to be updated.

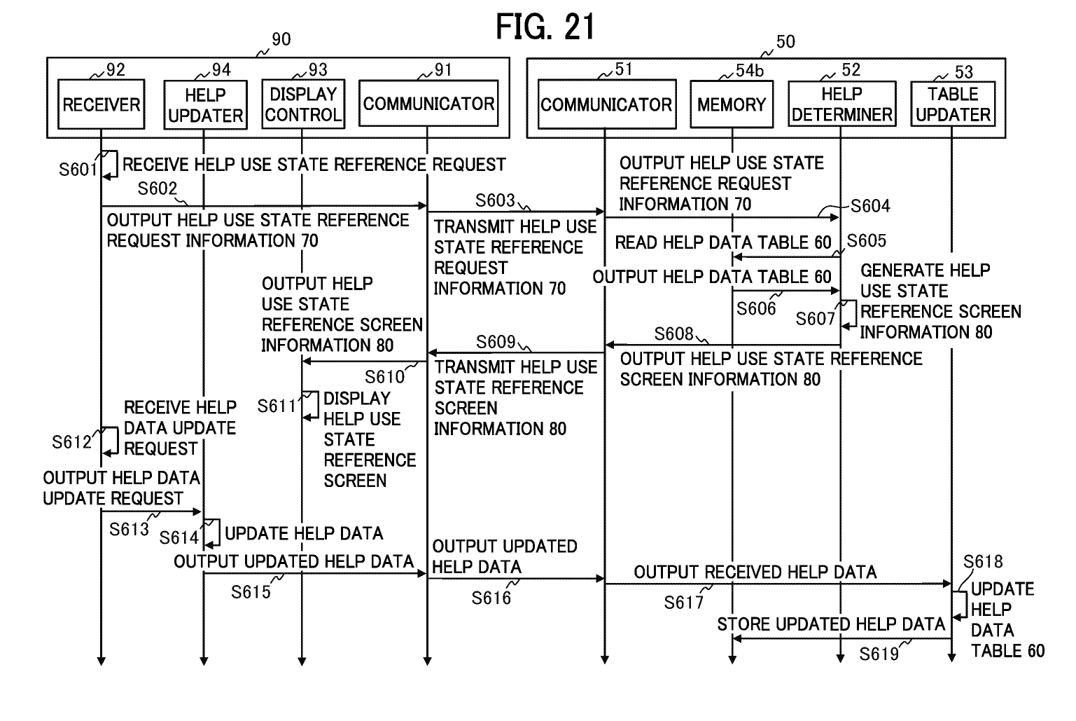

FIG. 21 is a sequence diagram illustrating an exemplary process performed in the help information providing system according to the embodiment for updating help data by referring to the use state of the help screen. In step S601, the receiver 92 of the communication terminal 90 receives a help use state reference request. Specifically, the receiver 92 receives a user input on an operation screen displayed on the display 506a by using input means such as the keyboard 505. In step S602, the receiver 92 outputs help use state reference request information 70 indicating a help use state reference request for the help server 50 to the communicator 91.

In step 603, the communicator 91 transmits the help use state reference request information 70 to the help server 50. In step S604, the communicator 51 of the help server 50 outputs the received help use state reference request information 70 to the help determiner 52. In step S605, the help determiner 52 reads the help data table 60 stored in the memory 54b. Specifically, the help determiner 52 outputs a read request to the storing and reading unit 54a to read the help data table 60. When the output read request is detected, the storing and reading unit 54a reads the help data table 60 stored in the memory 54b.

In step S606, the memory 54b outputs the help data table 60 to the help determiner 52. Specifically, the memory 54b outputs the help data table 60 to the storing and reading unit 54a. Then, the storing and reading unit Ma outputs the output help data table 60 to the help determiner 52.

In step S607, the help determiner 52 generates the help use state reference screen information 80 indicating a help use state reference screen by using the read help data table 60. For example, the help determiner 52 generates the help use state reference screen information 80 indicating the help use state reference screen 450a illustrated in FIG. 19 or the help use state reference screen 450b illustrated in FIG. 20. The help use state reference screen may have any other screen layout. In step S608, the help determiner 52 outputs the generated help use state reference screen information 80 to the communicator 51.

In step S609, the communicator 51 transmits the help use state reference screen information 80 output from the help determiner 52 to the communication terminal 90. In step S610, the communicator 91 of the communication terminal 90 outputs the received help use state reference screen information 80 to the display control 93.

In step S611, the display control 93 outputs the help use state reference screen information 80 to the display 506a. The display control 93 displays, for example, the help use state reference screen 450a or the help use state reference screen 450b on the display 506a. This allows the system administrator or the support person who uses the communication terminal 90 presenting the help use state reference screen to check (or refer to) the display screen to analyze the content of the help data. In addition, the help information providing system causes the communication terminal 90 that the system administrator or the support person uses to display an element included in the help use state reference screen, namely, the number of help screen requests, the number of non-uses of help screen, the number of help item selections, or the percentage of help screen use, to easily identify the help content 63 to be updated.

In FIG. 21, the help use state reference screen information 80 is transmitted from the help server 50 to the communication terminal 90 in accordance with a request from the communication terminal 90, by way of example. However, the help use state reference screen information 80 may be transmitted from the help server 50 to the communication terminal 90 when the help server 50 receives the help selection information 40 (e.g., the processing of step S310 in FIG. 16).

Alternatively, the help use state reference screen information 80 may be transmitted from the help server 50 to the communication terminal 90 when the setting information of the information processing apparatus 10 is changed (e.g., the processing of steps S502 to S505 and S507 in FIG. 18). Alternatively, the help use state reference screen information 80 may be transmitted from the help server 50 to the communication terminal 90 when the help server 50 receives the help non-use information 45 (e.g., the processing of step S407 in FIG. 17).

Next, a process for updating help data by the system administrator or the support person who uses the communication terminal 90 presenting the help use state reference screen will be described. In step S612, the receiver 92 of the communication terminal 90 receives a help data update request through a user input operation. Specifically, the receiver 92 receives a user input on the help use state reference screen displayed on the display 506a by using input means such as the keyboard 505.

In step S613, the receiver 92 outputs the help data update request to the help updater 94. In step S614, the help updater 94 updates the help data in accordance with the update request output from the receiver 92. Specifically, the help updater 94 updates the content of the help data included in the help use state reference screen displayed on the display 506a through a user input operation.

In step S615, the help updater 94 outputs the updated help data to the communicator 91. In step S616, the communicator 91 of the communication terminal 90 outputs the help data updated by the help updater 94 to the help server 50.

In step S617, the communicator 51 of the help server 50 outputs the received help data to the table updater 53. In step S618, the table updater 53 updates the help data table 60 by using the help data output from the communicator 51. In step S619, the table updater 53 stores the updated help data in the memory 54b.

The help data table 60, which is used to provide help information to the information processing apparatus 10, may be updated by using the communication terminal 90 that the system administrator or the support person uses. This allows the help information providing system to provide accurate help information by using the help data table 60, which is updated at any desired time, so that a user who has requested help information may be more likely to solve a problem alone.

As described above, the help information providing system according to the embodiment is a help information providing system for providing help information pertaining to an operation of the information processing apparatus 10 from the help server 50 to the information processing apparatus 10 via the network 5. The help server 50 acquires the help request information 30 indicating a request for the help information from the information processing apparatus 10, the help request information 30 including the device information 31 of the information processing apparatus 10 and the display screen information 32 indicating a display screen displayed on the information processing apparatus 10.

The help server 50 selects the help content 63 corresponding to the device information 31 and the display screen information 32 included in the acquired help request information 30 from the stored help data table 60. Then, the help server 50 generates, using the selected help content 63, the help screen information 35 indicating a help screen including instruction information for changing the setting information of the information processing apparatus 10, and transmits the generated help screen information 35 to the information processing apparatus 10. Accordingly, the help information providing system can provide help information so that a user may be more likely to solve alone a problem the user encounters with the information processing apparatus 10 during operation.

### First Modification of Embodiment

Next, a first modification of the embodiment will be described. The same or substantially the same configurations and the same or substantially the same functions as those in the embodiment described above are represented by the same numerals and will not be described herein. A help information providing system according to the first modification of the embodiment is capable of not only changing the setting information of the information processing apparatus 10 but also changing the state of resources through an operation on a help screen displayed on the information processing apparatus 10.

In the information processing apparatus 10, when a plurality of functions share a single resource, conflict may occur over the resource, which may prevent the information processing apparatus 10 from executing the functions. For example, when the facsimile application 25 is used, the flash memory 103 of the information processing apparatus 10 is shared for purposes such as temporary storage of transmission data during facsimile transmission and storage of received documents. If the flash memory 103 is full since received documents are stored, the information processing apparatus 10 is unable to perform facsimile transmission unless the space available in the flash memory 103 is increased by, for example, deleting received documents. Thus, when the information processing apparatus 10 is to perform facsimile transmission, an error message may be displayed on the operation panel 107.

Accordingly, in the help information providing system according to the first modification, a help screen provided from the help server 50 to the information processing apparatus 10 can be operated to change the state of a resource in the information processing apparatus 10, such as releasing the resource.

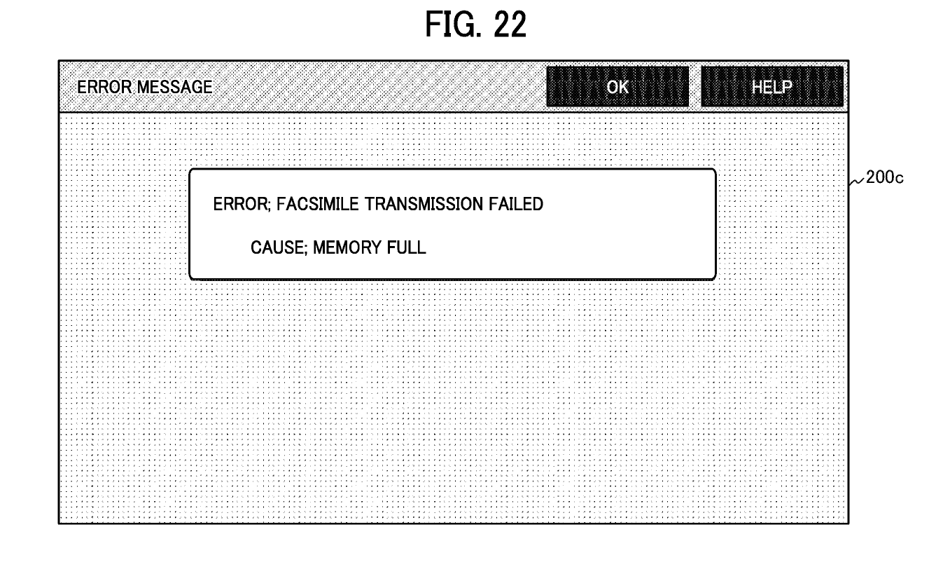

FIG. 22 illustrates an example display screen presented on the information processing apparatus according to the first modification of the embodiment before a help request is made. A display screen 200c illustrated in FIG. 22 presents an error message displayed on the operation panel 107 when facsimile transmission using the facsimile application 25 in the information processing apparatus 10 has failed. In this case, the error message on the display screen 200c indicates the cause of the error (e.g., memory full). The user of the information processing apparatus 10 selects a help icon in an upper right portion of the display screen 200c illustrated in FIG. 22 to transmit a help request to the help server 50. In this case, as in the embodiment described above, the information processing apparatus 10 transmits the help request information 30 including the device information 31 and the display screen information 32 indicating the display screen 200c to the help server 50.

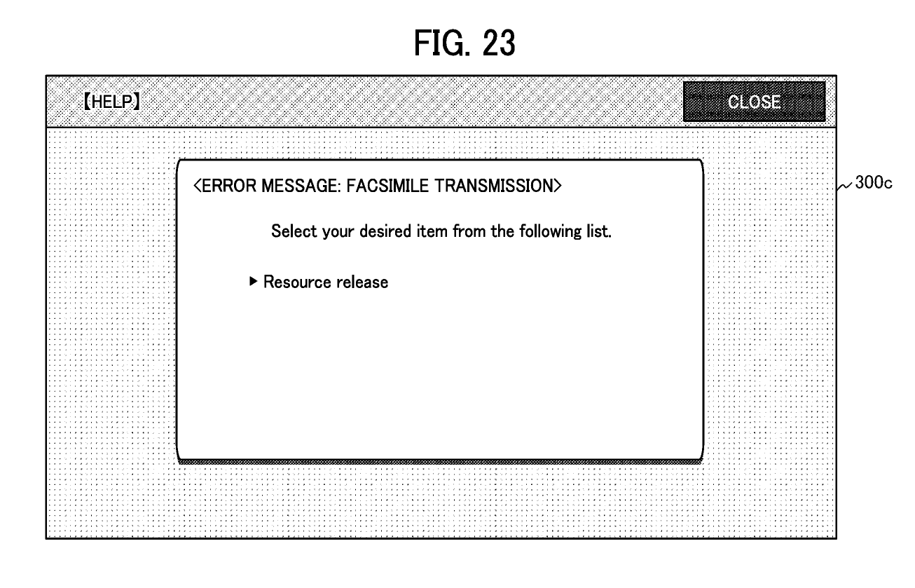

FIG. 23 illustrates an example of a help screen initially displayed on the information processing apparatus 10 according to the first modification of the embodiment. A help screen 300c illustrated in FIG. 23 is a help screen displayed on the information processing apparatus 10 that has transmitted the help request information 30 including the display screen 200c illustrated in FIG. 22.

When the help request information 30 including the help screen 300c is received, as in the embodiment described above, the help server 50 identifies the help information to be provided to the information processing apparatus 10 by using the help data table 60 illustrated in FIG. 6. Screen information included in the help data table 60 according to the first modification includes an item indicating an error message. Further, the display items and setting conditions for the help data table 60 according to the first modification include an item indicating a process that is being executed when an error occurs or an item indicating the cause of an error that has occurred.

The help data table 60 according to the first modification stores a resource, functions that share the resource, and an operation of releasing the resource as help data. If an error occurs in the information processing apparatus 10 due to conflict over a resource, the help server 50 selects the help content 63 for executing an operation of releasing the resource, and generates the help screen information 35 to be provided to the information processing apparatus 10. A specific process performed in the help server 50 up to the generation of the help screen 300c is similar to that in the embodiment described above.

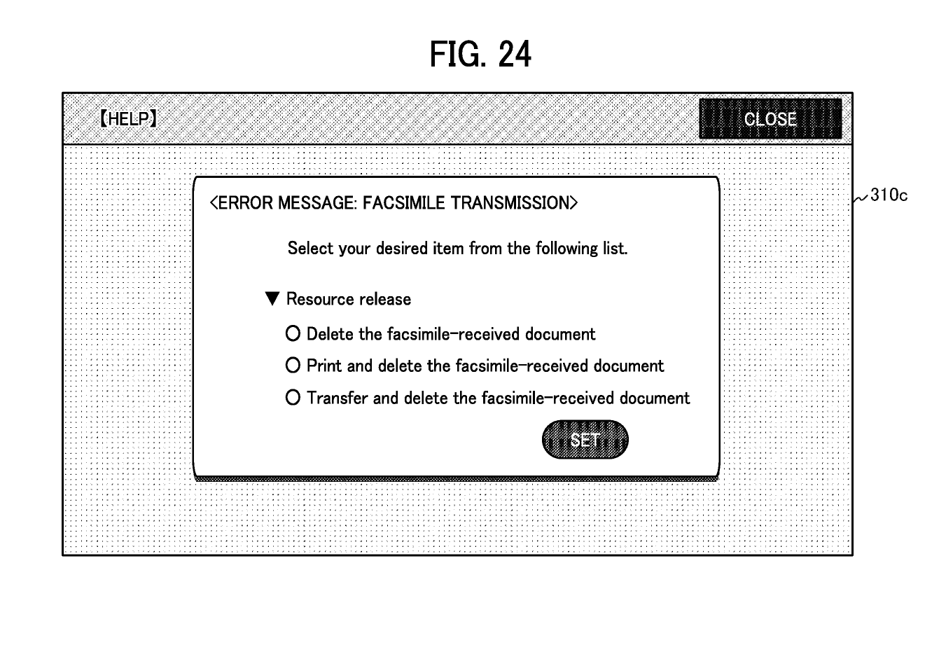

FIG. 24 illustrates an example of a help screen on the information processing apparatus 10 according to the first modification of the embodiment after a help item is selected. A help screen 310c illustrated in FIG. 24 is displayed on the operation panel 107 of the information processing apparatus 10 when the help item “resource release” is selected on the help screen 300c illustrated in FIG. 23. The help screen 300c illustrated in FIG. 24 presents help items “delete the facsimile-received document”, “print and delete the facsimile-received document”, and “transfer and delete the facsimile-received document” as processes for releasing the resource.

In response to receipt of the selection of the “SET” icon on the help screen 310c illustrated in FIG. 24, the help server 50 reflects the change in the state of the resource in the information processing apparatus 10, and the help screen 310c is closed. In the case of the help screen 310c illustrated in FIG. 24, the information processing apparatus 10 executes a process for releasing the resource to change the state of the resource.

In the help information providing system according to the first modification, accordingly, a help item for changing the state of a resource to overcome an error such as memory full is displayed on a help screen of the information processing apparatus 10. The user of the information processing apparatus 10 can select the displayed help item to change the state of a resource in the information processing apparatus 10 to overcome the error, and can execute the desired process.

### Second Modification of Embodiment

Next, a help information providing system according to a second modification of the embodiment will be described. The same or substantially the same configurations and the same or substantially the same functions as those in the embodiment described above are represented by the same numerals and will not be described herein. The help information providing system according to the second modification of the embodiment is capable of providing use authorization for the help content 63 to generate the help screen information 35 and providing different help information in accordance with the user of the information processing apparatus 10 that has transmitted the help request information 30.

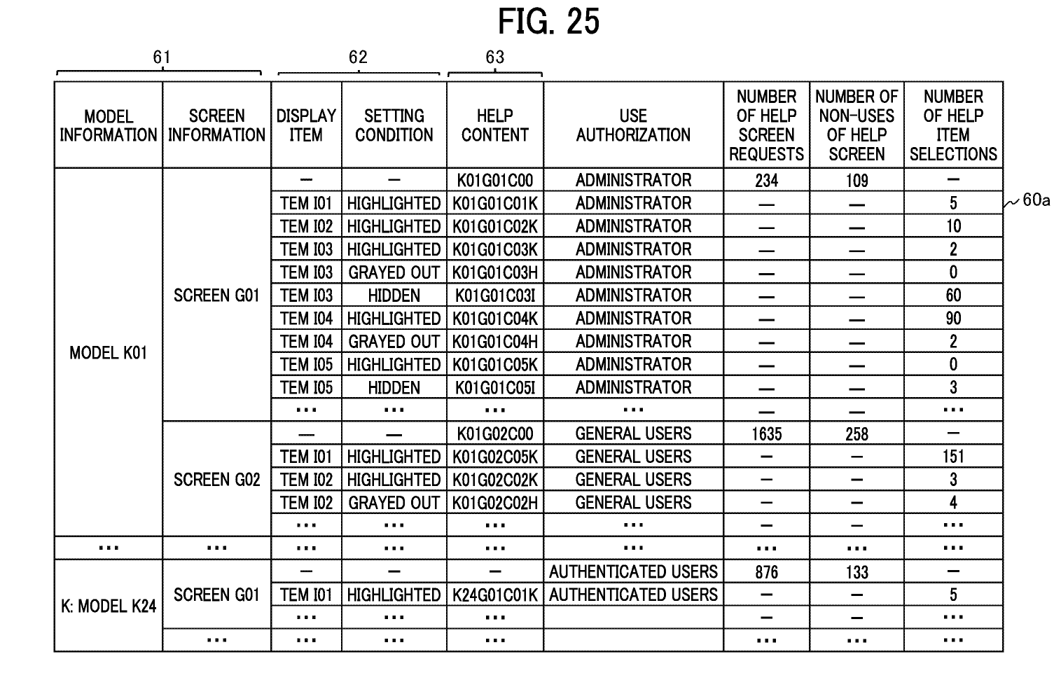

FIG. 25 illustrates an example of a help data table according to the second modification of the embodiment. A help data table 60a illustrated in FIG. 25 includes authorization information indicating use authorization for each piece of help content 63. In the help data table 60a illustrated in FIG. 25, use authorizations are classified into those granted to the administrator, to general users, and authenticated users. The help content 63 for which use authorization is granted to the administrator is content information that can be provided only to a user having administrator privilege. The help content 63 for which use authorization is granted to general users is content information that can be provided to all users. In contrast, the help content 63 for which use authorization is granted to authenticated users is content information that can be provided to users authenticated by the information processing apparatus 10.

In the help data table 60a, for example, use authorization for the help content 63 for the basic settings of the information processing apparatus 10 or settings that are to be charged is assigned. The help data table 60a may have a configuration in which use authorization is set for each piece of model information or screen information. The use authorizations included in the help data table 60a may be classified in any other way. The use authorizations may be classified by, for example, setting specific user names to further limit users who are authorized to use the help content 63.

The help request information 30 transmitted from the information processing apparatus 10 includes user information for determining the type of the user of the information processing apparatus 10. The user information includes, for example, a user name and a password. The help determiner 52 of the help server 50 selects the help content 63 to be used to generate the help screen information 35, in accordance with the user information included in the received help request information 30. For example, when the help request information 30 is received from a user who does not have administrator privilege, the help determiner 52 of the help server 50 selects a piece of help content 63 to be used to generate the help screen information 35 from among the pieces of help content 63 for which use authorization is granted to general users.

As described above, a help information providing system according to an embodiment of the present invention is a help information providing system for providing help information pertaining to an operation of the information processing apparatus 10 from the help server 50 (exemplary server apparatus) to the information processing apparatus 10 via the network 5. The help server 50 acquires the help request information 30 indicating a request for the help information from the information processing apparatus 10, the help request information 30 including the device information 31 of the information processing apparatus 10 and the display screen information 32 indicating a display screen displayed on the information processing apparatus 10. The help server 50 generates the help screen information 35 including a help item (exemplary instruction information) for changing the status of the information processing apparatus 10 in accordance with the acquired help request information 30, and transmits the generated help screen information 35 to the information processing apparatus 10. Accordingly, the help information providing system can provide help information so that a user may be more likely to solve alone a problem the user encounters with the information processing apparatus 10 during operation.

In the help information providing system according to the embodiment of the present invention, furthermore, the information processing apparatus 10 displays a help screen indicated in the transmitted help screen information 35 on a display unit (example of the operation panel 107). Then, the information processing apparatus 10 receives an operation for a help item (exemplary instruction information) included in the displayed help screen to change the status of the information processing apparatus 10. Accordingly, the help information providing system enables a user to collectively solve problems through the displayed help screen without causing the user to search for (or retrieve) a setting menu of the information processing apparatus 10.

In the help information providing system according to the embodiment of the present invention, moreover, the help server 50 (exemplary server apparatus) stores a plurality of pieces of help content 63 (exemplary help item) for generating the help screen information 35 in association with the device information 31 and the display screen information 32, and generates the help screen information 35 by using the help content 63 corresponding to the device information 31 and the display screen information 32 included in the acquired help request information 30. Accordingly, the help information providing system is capable of identifying a specific cause of a problem encountered by the user, by using the plurality of pieces of help content 63 stored in the help server 50. Then, the help information providing system can provide the user with help information indicating a more beneficial solution including instruction information that allows the user to directly solve the problem.

In the help information providing system according to the embodiment of the present invention, furthermore, the help server 50 (exemplary server apparatus) receives information indicating whether the help content 63 (exemplary help item) included in the transmitted help screen information 35 has been used, and stores the number of times the help content 63 included in the transmitted help screen information 35 has been used. Then, the help server 50 generates the help screen information 35 by using the help content 63 that has been used the largest number of time Accordingly, in the help information providing system, the help server 50 generates the help screen information 35 by preferentially using frequently used help content 63, resulting in it being more likely that the time taken for the user to solve a problem will be shortened.

In the help information providing system according to the embodiment of the present invention, moreover, the help server 50 (exemplary server apparatus) stores the number of times the help content 63 (exemplary help item) included in the transmitted help screen information 35 has not been used. Thus, the help information providing system allows the administrator or the support person of the help information providing system to easily identify the help content 63 that is not help information beneficial to the user, efficiently updating help information to be provided.

In the help information providing system according to the embodiment of the present invention, furthermore, the help server 50 (exemplary server apparatus) stores the help content 63 (exemplary help item) in association with authorization information indicating authorization to use the help content 63, and generates the help screen information 35 by using the help content 63 that the user who has transmitted the help request information 30 is authorized to use. Accordingly, the help information providing system can provide different help information in accordance with the user of the information processing apparatus 10 that has transmitted the help request information 30.

In the help information providing system according to the embodiment of the present invention, moreover, if the information processing apparatus 10 fails to acquire the help screen information 35 from the help server 50 (exemplary server apparatus), a pre-stored display screen indicating help acquisition failure is displayed on the display unit (example of the operation panel 107). This allows the help information providing system to present the cause of unsuccessful acquisition of help information to the user in a separate manner from other causes such as a cause of unsuccessful communication with the help server 50 due to failure in the network 5.

Further, the help information providing system according to the embodiment of the present invention includes the communication terminal 90 configured to receive the help use state reference screen information 80 indicating the use state of the help content 63 (exemplary help item), which is transmitted from the help server 50 (exemplary server apparatus). Then, when information indicating that the help content 63 included in the transmitted help screen information 35 has been used is received from the information processing apparatus 10, the help server 50 transmits the help use state reference screen information 80 to the communication terminal 90. Accordingly, the help information providing system can use the communication terminal 90 that the system administrator or the support person uses, to update the help data table 60 that is used to provide help information to the information processing apparatus 10. In addition, the help information providing system can provide accurate help information by using the help data table 60, which is updated at any desired time, so that a user who has requested help information may be more likely to solve a problem alone.

Moreover, a help information providing method according to an embodiment of the present invention is a help information providing method executed by a help information providing system for providing help information pertaining to an operation of the information processing apparatus 10 from the help server 50 (exemplary server apparatus) to the information processing apparatus 10 via the network 5. The help information providing method includes an acquisition step of acquiring, by the help server 50, the help request information 30 indicating a request for the help information from the information processing apparatus 10, the help request information 30 including the device information 31 of the information processing apparatus 10 and the display screen information 32 indicating a display screen displayed on the information processing apparatus 10; a generation step of generating, by the help server 50, the help screen information 35 including a help item (exemplary instruction information) for changing the status of the information processing apparatus 10 in accordance with the acquired help request information 30; and a transmission step of transmitting the generated help screen information 35 from the help server 50 to the information processing apparatus 10. Accordingly, a help information providing method according to an embodiment of the present invention can provide help information so that a user may be more likely to solve alone a problem the user encounters with the information processing apparatus 10 during operation.

Functions in each embodiment may be implemented by a computer-executable program written in a legacy programming language, such as assembler, C, C++, C#, or Java (registered trademark), or an object-oriented programming language, and a program for executing functions in each embodiment may be distributed via a telecommunications line.

Further, a program for executing functions in each embodiment may be stored in and distributed through a device-readable recording medium such as a ROM, an EEPROM, an erasable programmable read-only memory (EPROM), a flash memory, a flexible disk, a compact disc ROM (CD-ROM), a CD Rewritable (CD-RW), a digital versatile disc ROM (DVD-ROM), a DVD-RAM, a DVD-RW, a Blu-ray disc, a secure digital (SD) card, or a magneto-optical (MO) disc.

Furthermore, some or all of functions in each embodiment may be implemented on a programmable device (PD) such as a field programmable gate array (FPGA) or implemented as an ASIC. Alternatively, functions in each embodiment may be distributed through a recording medium as circuit configuration data (bit stream data) to be downloaded into a PD to implement the functions in each embodiment on the PD, or data written in a hardware description language (HDL), a very high speed integrated circuits hardware description language (VHDL), or Verilog-HDL to generate the circuit configuration data.

While a help information providing system, a help information providing method, and a program according to embodiments of the present invention have been described, the present invention is not limited to the embodiments described above, and modifications such as adding another embodiment, changing an embodiment, or deleting an embodiment may be made so long as such modifications can be made by a person skilled in the art, and any aspect that achieves the operations and effects of the present invention is included in the scope of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A system for providing help information, comprising:
processing circuitry configured to:
acquire, from an information processing apparatus, help request information indicating a request for help information relating to an operation of the information processing apparatus, the help request information including device information of the information processing apparatus and display screen information indicating a display screen displayed on the information processing apparatus;
generate help screen information in accordance with the acquired help request information, the help screen information including instruction information for changing a status of the information processing apparatus; and
transmit the generated help screen information to the information processing apparatus via a network.

2. The system according to claim 1, wherein the display screen information includes information indicating the status of the information processing apparatus.

3. The system according to claim 1, further comprising:
a memory configured to store a plurality of help items for generating the help screen information in association with the device information and the display screen information, and
the processing circuitry is configured to generate the help screen information by using a help item corresponding to the device information and the display screen information included in the acquired help request information among the plurality of stored help items.

4. The system according to claim 3, wherein
the processing circuitry is configured to receive information indicating whether a help item included in the transmitted help screen information has been used,
the memory is configured to store the number of times a help item included in the transmitted help screen information has been used, and
the processing circuitry is configured to generate the help screen information by using a help item that has been used a largest number of times.

5. The system according to claim 4, wherein the memory is configured to store the number of times a help item included in the transmitted help screen information has not been used.

6. The system according to claim 3, wherein
the memory is configured to store authorization information in association with each of the plurality of help items, the authorization information indicating authorization to use the help item, and
the processing circuitry is configured to generate the help screen information by using a help item that a user who has transmitted the help request information has authorization to use.

7. The system according to claim 1, further comprising:
another processing circuitry being different from the processing circuitry, the another processing circuitry being disposed on the information processing apparatus; and
a display provided for the information processing apparatus,
the another processing circuitry of the information processing apparatus being configured to:
display on the display a help screen based on the help screen information; and
change the status of the information processing apparatus in response to reception of an operation based on the instruction information included in the help screen.

8. The system according to claim 7, wherein the another processing circuitry of the information processing apparatus is configured to cause the display to display a pre-stored display screen indicating help acquisition failure in response to failing to acquire the help screen information.

9. The system according to claim 7, further comprising:
a communication terminal configured to receive help use state reference screen information indicating a use state of a help item, the help use state reference screen information being transmitted from a server apparatus, the server apparatus including the processing circuitry,
wherein the processing circuitry of the server apparatus is configured to transmit the help use state reference screen information to the communication terminal in response to receipt of information from the information processing apparatus, the information indicating that a help item included in the transmitted help screen information has been used.

10. A method for controlling display of help information, performed by an information processing apparatus, the method comprising:
transmitting, to a server apparatus, help request information indicating a request for help information relating to an operation of the information processing apparatus, the help request information including device information of the information processing apparatus and display screen information indicating a display screen displayed on the information processing apparatus;
receiving help screen information generated in accordance with the transmitted help request information via a network, the help screen information including instruction information for changing a status of the information processing apparatus; and
displaying on a display a help screen based on the received help screen information.

11. The method according to claim 10, further comprising:
changing the status of the information processing apparatus in response to reception of an operation based on the instruction information included in the help screen.

12. The method according to claim 11, further comprising:
displaying, on the display, a pre-stored display screen indicating help acquisition failure in response to failing to acquire the help screen information from the server apparatus.

13. A non-transitory recording medium storing a plurality of instructions which, when executed by one or more processors, cause the processors to perform a method for providing help information, comprising:
acquiring, from an information processing apparatus, help request information indicating a request for help information relating to an operation of the information processing apparatus, the help request information including device information of the information processing apparatus and display screen information indicating a display screen displayed on the information processing apparatus;
generating help screen information in accordance with the acquired help request information, the help screen information including instruction information for changing a status of the information processing apparatus; and
transmitting the generated help screen information to the information processing apparatus via a network.

14. The recording medium according to claim 13, wherein the method further comprises:
storing in a memory a plurality of help items for generating the help screen information in association with the device information and the display screen information,
wherein the generating help screen information includes generating the help screen information by using a help item corresponding to the device information and the display screen information included in the acquired help request information among the plurality of stored help items.

15. The recording medium according to claim 14, wherein the method further comprises:
receiving information indicating whether a help item included in the transmitted help screen information has been used; and
storing in the memory the number of times a help item included in the transmitted help screen information has been used,
wherein the generating help screen information includes generating the help screen information by using a help item that has been used a largest number of times.

16. The recording medium according to claim 14, wherein the method further comprises:
storing in the memory authorization information in association with each of the plurality of help items, the authorization information indicating authorization to use the help item,
wherein the generating help screen information includes generating the help screen information by using a help item that a user who has transmitted the help request information has authorization to use.
